(19) United States
(12) Patent Application Publication
(10) Pub. No.: US 2011/0043328 A1
(43) Pub. Date: Feb. 24, 2011

(54) Advanced Vehicular Universal Transmitter Using Time Domain With Vehicle Location Loggin System

(76) Inventor: Fred Bassali, Great Neck, NY (US)

Correspondence Address: SOFER & HAROUN LLP., 317 MADISON AVENUE, SUITE 910, NEW YORK, NY, 10017, US

(21) Appl. No.: 12/664,262

(22) PCT Filed: Jan. 7, 2008
(86) PCT No.: PCT/US08/00198

§ 371 Date: Nov. 15, 2010

Related U.S. Application Data
(60) Provisional application No. 60/898,090, filed on Jan. 29, 2007.
(60) Provisional application No. 60/900,393, filed on Feb. 8, 2007.
(60) Provisional application No. 60/904,200, filed on Feb. 28, 2007.
(60) Provisional application No. 60/905,927, filed on Mar. 8, 2007.

(51) Int. Cl. G08C 19/00

(52) U.S. Cl. 340/5.71

(57) ABSTRACT

Special time domain techniques with novel circuitry are implemented for instantaneous precision frequency measurement of a signal comprised of short bursts emitted from a reference transmitter. Carrier frequency of the bursts is determined either by a special gated frequency counter or high speed sampling and spectral analysis. As a result of inherent precision frequency measurement and reproduction by using time domain techniques, the range of a combined unit, i.e., universal garage door openers UGDO and remote keyless entry RKE which is referred to as UT (Universal Transmitter) is further improved. Instantaneous determination of frequency and code of the reference transmitters is achieved and training procedure difficulties/failures which occur from auto-shutoff feature are totally eliminated. A new function for logging the most recent location of the vehicle is implemented on a fob or a key fob, referred to as RLV (Recent Location of Vehicle) unit which can be an added to a UT and/or RKE or can be realized as a standalone unit. High performance antenna with a reliable and stable impedance match is achieved by realization of novel wideband techniques. Dual-band operation, i.e., European and North American bands is easily implemented without the need for additional hardware. The dilemma of utilizing a universal opener for reproduction of rolling codes (which were devised to prevent reproduction) is resolved by means of user authentication.

### RELATED APPLICATIONS

This application is a National Phase Application of PCT Patent Application No. PCT/US08/00198, filed on Jan. 8, 2009, which claims the benefit of priority form U.S. Provisional Patent Application Nos. 60/898,090, filed on Jan. 29, 2007; 60/900,393, filed on Feb. 8, 2007; 60/904,200, filed on Feb. 28, 2007; and 60/905,927, filed on Mar. 8, 2007, the entirety of which are incorporated by reference.

### BACKGROUND

Universal garage door openers (UGDO) are devices which are integrated as parts of motor vehicles and learn characteristics of a reference transmitter. They provide convenience to the user, e.g., no battery changes are required, the transmitters are not easily subject to theft since they are integrated parts of the vehicle and a single UGDO can be programmed for multiple gates or garage doors.

Remote keyless entry (RKE) systems are devices typically implemented in small hand-held fobs attached to the key chain or built-in as a part of the ignition key or other keys (e.g., door key trunk key) and are used for remotely lock, unlock, access premises or automobiles, activate an alarm, disarm an alarm, open trunk start the engine, etc.

Many other devices controlled by RF remotes, e.g., lights, shades, home locks for entry to a house, lowering/opening a gate. Especially in the recent years house locks controllable by a remote has become very popular. Thereby, to avoid multiple keys and remote control fobs a single universal device which can learn the frequency and the code of any of these devices can be used to replace various devices, i.e., a fob or an ignition key with a fob with multiple trainable buttons, e.g., 6 buttons, can be trained and used for open a garage door, keyless entry to car and locking the car, unlock the building door, Lock and unlock apartment door, start the engine remotely, etc.

A universal transmitter (UT) can be implemented as a combination of a UGDO together with an RKE transmitter placed in a fob or a key fob which is portion of ignition key or other keys (e.g., door key, trunk key). In addition, a device that logs the most recent location of the vehicle herewith referred to as an RLV (Recent Location of Vehicle) unit can be implemented on the fob or key fob containing a UT.

Additional functions can be implemented on the remote entry system which can benefit the operator of the vehicle. I.e., frequently when operators of vehicles park their vehicle in busy urban areas they forget the location of where the vehicle was parked. Modern vehicles are often equipped with GPS receivers which track the geographic location and the corresponding address of the vehicle. The address of where the vehicle was parked, i.e., where the ignition was last turned off can be saved in the RKE module (fob or ignition key) for future reference if there is a necessity.

The advent of low cost high speed digital signal processing such as DSP's, FPGA's, DDS's and multi-GHz processors is utilized which make the present invention attainable at low cost.

The prior art UGDO's have limitations in several aspects leading to reduced performance, e.g., frequency measurement of the reference transmitter is prone to error and as a result of inaccurate frequency is transmitted which leads to reduced receiver sensitivity and reduced range.

The present invention uses special time domain techniques providing precise methods for frequency measurement of the reference transmitters which their signals are comprised of RF bursts.

There is a fundamental dilemma regarding learning and reproducing rolling codes, i.e., rolling codes were initially implemented so that no one could regenerate them. However, the owner of a vehicle with a UGDO expects that the universal device available on his/her vehicle should function regardless of the type of code his/her garage door opener is producing. On the other hand, once the universal devices can learn and reproduce rolling codes, a potential intruder, e.g., a parking attendant who often has temporary access to vehicles, can train a UGDO and use it for theft which forfeits the security expected from the use of rolling codes.

### Deficiencies of Prior Art Universal Openers

(1) Error in Frequency Measurement—The prior art uses a frequency sweep method identification, i.e., the frequency of the reference transmitter is assessed by consecutively hopping to different frequency windows until the presence of signal is detected. The frequency sweep method does not provide accurate frequency measurements. During the training procedure, when the UGDO is brought close to the reference transmitter. The spacing between frequency windows is typically 1 MHz. The adjacent frequency windows also detect out of band signal due to the fact that the receive level is very high and there is a limited rejection of out of band signals provided by skirts of the IF filters. The average frequency of the windows is used as the estimate for the frequency of the reference transmitter. This method is prone to error. The uneven characteristics of the antenna and receiver circuits versus frequency can easily cause error in evaluation of frequency, i.e., the signal level at a frequency window can fall bellow the threshold while at the symmetrical window (with respect to the reference transmitter) the signal can fall above threshold. Another source of frequency error is when the frequency of the reference transmitter is not at the center point of the measurement window. In such instances the assessed frequency of the reference transmitter is rounded up. As a result of these errors, the UGDO's which are built according to the prior art, can potentially transmit at incorrect frequencies and thereby have reduced range. As, the garage door opener receivers typically have relatively narrow bandwidths (0.5-2 MHz). A frequency error of 1 MHz in some cases corresponds to several decibels of reduced receiver sensitivity which leads to a significant loss of range of UGDO.

(2) Mismatch Losses—The prior art uses a varactor diode which provides a series capacitance to the antenna for canceling the inductive reactance of the antenna. The bias voltage across the varactor diodes is changed for different frequencies accordingly. The required bias voltage is retrieved from a table-lookup in a memory device and is supplied to the varactor diode by a D/A converter. However, as it is explained below, the statistical and temperature changes of varactor diode capacitance can cause significant mismatch losses. Small antennas have typically a very low radiation resistance in comparison to their reactance. Therefore, in the antennas which are small and fit in UGDO housings the same is true, i.e., the reactance of such antennas is quite larger than their radiation resistance (typically on the order of 25-100 times) which corresponds to a narrowband or equivalently high Q bandpass in the antenna match characteristics. As a result, the resonance of such a high Q antenna with a varactor diode provides a narrowband match (a few percent) is subject to drastic changes with a small change in the capacitance of the varactor diode. Changes in characteristics of varactors (Capacitance versus Voltage) arising from the temperature changes and also statistical variations of varactor diodes lead to antenna mismatch which results in lower transmit power and consequently loss of range.

The effect of temperature on capacitance of varactor diodes is analyzed bellow.

The relationship between the capacitance, bias voltage and temperature in a hyperabrupt varactor diode incorporated in here from references [1] and [2] is given by:

$$C = \frac{{C}_{0}}{{( 1 + \frac{{V}_{R}}{Φ} )}^{2}} \qquad ( 1 )$$

Where, C is capacitance the capacitance of the varactor diode at the bias voltage V_{R} and C₀ is the capacitance at zero bias given by:

$${C}_{0} = A \sqrt{\frac{qN ɛ}{2 Φ}} \qquad ( 2 )$$

Where, A is the junction area, q is charge of electron, N=N_{d}·Nₐ/(N_{d}+Nₐ), N_{d} is donor density, Nₐ is acceptor density, ε is permittivity and Φ is the barrier potential given by:

$$Φ = 2 \frac{kT}{q} ln \frac{AW}{2 {n}_{i}} \qquad ( 3 )$$

Where, k is Boltzmann's constant, T is absolute temperature, W is the total space charge layer width and nᵢ is the electron density in the intrinsic semiconductor. As the equations (1)-(3) indicate, C increases with increase in temperature at low bias voltages (V_{R}≈0) and C decreases with increase of temperature at high bias voltages (V_{R}>>Φ).

A quantitative analysis of the equation (3) indicates that a 30 degree drop of T from room temperature of 300° k (10%) causes 10% drop of Φ which in turn causes a 5% drop in capacitance C [equations (2) and (1)] at low voltages. However, the same temperature drop causes an increase of capacitance of the varactor by 15% at high bias voltages.

The variations of varactor capacitance used in the prior art cause a major mismatch leading to moderate to significant reduction of range in the prior art UGDO's. The present invention utilizes techniques which do not require a narrowband tuning for the antenna match and nor a varactor diode is used in conjunction with the antenna.

(3) Training Problems of Reference Transmitters with Auto-shut-off—In the prior art UGDO's, a super-heterodyne receiver is utilized in order to find the frequency of the reference transmitter. The super-heterodyne receiver goes through frequency sweeps of the entire UGDO band. This procedure often takes quite a long time during which the reference transmitters could go to an auto-shut-down (auto shut down is implemented in some garage door opener transmitters) leading to training failure. The present invention, however, utilizes time domain technique for capturing frequency and the code of the signal from the reference transmitter which yields immediate capture of the code and frequency of the signal.

(4) Training Problems of Small Duty Cycle Reference Transmitters—Another source of problem in the prior art devices can arise from a low duty cycle of the reference transmitter, i.e., when the transmission period of the reference transmitter is too short, and/or the time between consecutive transmissions is too long, the prior art UGDO receivers could easily miss the signal by hopping to the next frequency window before the detection of the signal. This is avoidable in the present invention as the present invention utilizes time domain techniques in which the capture of signal is instantaneous.

(5) Training Problems Due to Variances in Signal Receive Level—There are several causes for variances in the receive signal level during the training process:
(a) Garage door opener transmitters transmit different peak powers. Depending on the frequency and the duty cycle, the regulation allows different peak transmit power and manufacturers comply and set the peak levels of the signal close to the maximum allowable level which vary from unit to unit. Characteristically, there is a variance of 10 decibels between the peak power of the signal emitted from different garage door openers.
(b) The received signal levels vary with respect to the angle between the antennas of the reference transmitter and the UGDO. The variation of angle could cause significant signal level changes, i.e., when the polarization of transmitter and receiver are the same, the receive level is at its maximum and when polarizations are orthogonal, the receive level is at its minimum. Typically there can be 25 decibels of variation between the maximum and minimum levels from due to polarization mismatches.
(c) During the training procedure, the users hold the reference transmitter at different relative distances from the UGDO. This alone can cause a significant variance in the receive level, i.e., when the reference transmitter is held in the fairly close vicinity of UGDO, the antennas are operating in their near field regions. Antenna theory predicts that antennas have both peaks and nulls in their near field patterns which cause significant variations in the receive signal when their respective positions are moved even by a short distance. Typically there can be 15 decibels of variation between the maximum and minimum levels due to variations in distance.

These variances in the receive signal level during the training procedures could lead to training failure resulting in detection errors. When the signal level can be too low, it leads to detection error. A high (logical-1) signal can fall below threshold and be interpreted as a low (logical-0) signal, or when there is excessive receiver gain and as a result the receive signal level is too high, noise can fall above the threshold and be interpreted as a high (logical-1). The present invention has eliminated this problem by utilizing an adjustable gain amplifier in conjunction with an amplitude detector and the circuitry as a result of which provide a standard signal level to is supposed to signal processing section of the UT.

(6) In-band Signal Roll-off—In the prior art devices, a frequency synthesizer with an ordinary VCO is used as the signal source for the transmitter. Ordinary VCO's signals typically contain moderate amount of second harmonic. As, any small imbalance in the shape of the compressed waveform, i.e., one side of the waveform is more compressed than the other side (this could occur from temperature changes or even statistical variations of circuit components) corresponds to the presence of 2^{nd} and the other even harmonics. The fundamental frequency of the signal for UGDO is in the range of 200-400 MHz and the corresponding second harmonic is 400-800 MHz which necessitates an extremely sharp filter at corner frequency of 400 MHz. Inevitably, there is a roll off present in the filter at the high end of the UGDO frequency band. As a result, even very high order filtering schemes are inadequate for reducing the harmonic and not affecting the fundamental at the higher end of the band.

(7) Potential use by intruders with high security codes—In some of garage door opener systems which are available in the market, in order to prevent copying of the code and frequency by potential intruders, rolling codes are used, i.e., the receiver does not respond to a code that was recently used and responds to certain new codes that are identifiable by the receiver circuitry. Owners of vehicles which are equipped UGDO's more often have garage door openers which work with rolling codes. To accommodate those users, the prior art UGDO's are also designed to produce rolling codes. However, manufacturing trainable garage door openers which can be trained to reproduce rolling codes is quite dilemmatic and contradictory to the concept which rolling codes were intended for. A potential intruder, e.g., a parking attendant who has temporary access to vehicles, can train a UGDO to learn rolling codes and use it to break into a gate or garage door which is intended to be very secure as a result of use of rolling codes. Therefore reproduction of rolling codes by UGDO's forfeits the sense of security which is provided to the user of a garage door opener which operates with rolling codes. The present invention has resolved this dilemma by use of an authentication device/method after it is temporarily disabled. Examples of authentication hardware are keypads for entering a code, biometric identification devices such as fingerprint sensors, voice recognition devices, etc.

### SUMMARY

The present invention simplifies the circuit implementation of universal garage door openers (UGDO) and provides a higher performance device than the prior art in several aspects.

The UT's manufactured according to the present invention provide the maximum possible range for any given frequency and code combination regardless of manufacturing tolerances and temperature effects and eliminates the various problems which occur during the training procedure by:

(1) Use of time domain for determining the frequency. Special techniques utilized which are highly accurate for determining the frequency of the reference transmitter.
(a) Use of High Frequency Sampling. According this embodiment of the present invention, the incoming signal is time-sampled and subsequently analyzed by a Fast Fourier Transform (FFT) algorithm rendering the carrier frequency of the reference transmitter.
(b) Use of a gated counter for measuring the frequency of the incoming bust. In this preferred embodiment, a built-in “gated-frequency counter” in conjunction with amplitude detection and delay line circuits are utilized in order to determine the carrier frequency of the reference transmitter.

(2) Immediate capture of the reference transmitter signal—Since the duration of each burst is quite short, a gated-counter is enabled when the presence of a signal is detected by an amplitude detector. In the alternative scheme in which sampling is used, the signal from the reference transmitter is captured from its beginning. Thereby, capture of the signal from any reference transmitter is instantaneous and signals cannot be missed under any circumstances including transmitters that utilize an auto shut off feature.

(3) Standard signal level for receiver signal processing—By using a programmable amplifier in conjunction with detector circuitry in the receiver section, problems arising from variations in the receive signal level is diminished.

(4) Use of same unit for all bands and modulation—According to this embodiment, when the high frequency sampling is utilized, the signal processing for demodulation as well as signal generation for transmission is handled by software. The modulation characteristics of the reference transmitter, i.e., AM or FM and index of modulation are evaluated numerically without requiring any additional hardware, e.g., frequency discriminators. Therefore, the same unit can be used for both bands and types of modulation schemes, i.e., FSK (FM) and OOK (AM) and both European (VHF) and North American (UHF) (i.e., 25-40 MHz and 200-450 MHz) bands without the need for any major additional hardware components such as VCO's, separate frequency discriminator circuitry, modulator circuitry. Likewise, since signal modulation during transmitting is done numerically, separate generators for different bands or modulation types are unnecessary.

Special dual-band space-saving antennas are implemented and utilized in which dual band antennas are implemented by placing loop radiators inside each other. The antennas provide wideband reception for both European and North American bands. This is done by implementation of multi-radiating-element antennas and for the case of dual band two of such antennas are connected together.

(5) Generation of Harmonic-less signal—Utilization of special time domain and digital techniques provides a superior performance. In the present invention a true sinusoidal signal is generated by one of these methods which have high frequency stability as well as low harmonics:
(a) Numerical signal generation for transmitter signal. This is done by numerically constructing a digital sine wave signal which is subsequently converted to analog format by a Digital to Analog Converter (DAC).
(b) Use of DDS (Direct Digital Synthesis) techniques.
(c) Use of dual-feedback VCO's in conjunction with a staircase generator. Use of a gated counter in conjunction with a staircase generator to stabilize the frequency of a VCO (preferably a dual-feedback VCO) provides instantaneous frequency dialing. Unlike the PLL's used in the prior art in which there is delay due to the PLL settling time.

According to the present invention, the UT utilizes numerical signal generation which produces sine waves that are inherently harmonics free. Technologies such as SiGe, BICMOS, GaAs, HBT and high speed CMOS which have become available in the recent years play the essential role in low costs realization.

The sinusoidal waveforms produced by use of DAC's or DDS's or dual-feedback VCO's have inherently low harmonic contents in the entire UT frequency band and filtering requirement for signals produced by them is very simple. The prior art UGDO's utilize ordinary Voltage Controlled Oscillators (VCO) which have compressed peaks inherently contain excessive harmonic contents that need to be filtered out in order to meet the regulations. As a result, in the prior art UGDO's the harmonics of lower portion of the band which fall on the higher portion and/or the nearby frequencies which are attenuated by the harmonic reject filter the UGDO's of prior art, emit lower than allowable transmit power at their high end of the frequency spectrum.

(6) Simple filtering—The present invention requires simple (low order) filtering for suppressing the distortion in dual feedback VCO's or quantization noise and distortion produced by nonlinearity of digital to analog converters which are several orders of magnitude smaller than the harmonic signal resulted from compressed waveforms produced by the ordinary VCO's. The frequency spectrum of quantization noise and harmonics generated nonlinearity of digital to analog converters (DAC) in the present invention are several octaves away from the corner frequency of the filter. Therefore, a simple filtering is sufficient.

(7) High Security from potential intrusion—The present invention has resolved the problem of the frequency and codes (rolling or regular) being copied by intruders. This is done by use of an authentication procedure prior to transmission of a signal. Examples of hardware used for authentication are keypads for entering a code, biometric identification devices such as fingerprint sensors, voice recognition devices, etc. In a preferred embodiment of the present invention, an authentication course of action is required for every time that one of the buttons on the UT is pressed. In another preferred embodiment of the present invention, an authentication course of action is required only after the UT is locked.

### BRIEF DESCRIPTION OF DRAWINGS

FIG. 1 shows an implementation of the present invention using digital to analog conversion for digital processing of the signal from the reference transmitter. The frequency of the reference transmitter is determined by an FFT algorithm. The carrier signal is generated numerically and subsequently is converted to analog.

FIG. 2 shows the flow chart for the training procedure for a UT implementation as described in block diagram of FIG. 1.

FIG. 3 shows an implementation for a UT using amplitude sampling for determining the presence of signal and a gated-frequency counter for measuring the frequency during the presence of signal.

FIG. 4 shows that when a sine wave is sampled at a rate of three samples/cycle and under no circumstance two 2 consecutive samples can fall below certain threshold level.

FIG. 4a shows the input-output characteristics of a magnitude digitizer circuit.

FIG. 4b shows a possible implementation for a magnitude digitizer circuit.

FIG. 4c shows an implementation for a multi-sampler (voter) circuit which can be used for the UT implementation depicted in FIG. 3.

FIG. 5 shows an implementation for the present invention using a gated-frequency counter for determining the carrier frequency of the reference transmitter and using an envelope detector circuit for determining the code which is modulating the reference transmitter.

FIG. 6 shows implementation of a delay line discriminator (a type of FM demodulator) which utilizes a bank of delay lines. The appropriate combination of delay lines are selected in order to demodulate FM signals in the entire garage door openers FM-band.

FIG. 7 depicts a typical block diagram of a DDS system comprised of a phase accumulator, a waveform mapping device a Digital to Analog Converter and a lowpass filter. Use of a DDS system is a preferred embodiment for a signal source for transmitter since it has very low distortion and high frequency stability.

FIG. 8a depicts a block diagram of an ordinary VCO which its output is a distorted sine wave.

FIG. 8b depicts a possible implementation for the block diagram of a dual feedback VCO which produces low distortion sinusoidal signal and contains a VCO similar to the one in FIG. 8a. Additional feedback loop is to provide negative feedback to limit the loop gain in the oscillation mechanism and thereby limit the amplitude of the signal generated by VCO at a level which the signal is sinusoidal is essentially distortion-less.

FIG. 9a depicts a possible implementation of a wide band antenna comprised of only three sections connected in series. Each section is comprised of a loop radiating element in parallel with a capacitance.

FIG. 9b depicts a possible implementation of a wide band antenna comprised of only three sections connected in parallel. Each section is comprised of a loop radiating element in series with a capacitance.

FIG. 9c depicts a possible implementation of a “hybrid mode” (combination of series and parallel resonances) antenna used for a wide band operation.

FIG. 9d is a depiction for the space savings variation to the hybrid mode antenna of FIG. 9c wherein, the reduction in the antenna size is accomplished by choosing different dimensions for the loop radiating elements and placing them inside each other.

FIG. 9e is also a depiction for a space savings implementation for a hybrid mode antenna similar to the implementation of FIG. 9d in which portions of the radiating elements are shared between the radiators.

FIG. 9f is a depiction for the space savings variation to the antenna of FIG. 9a. The reduction in the antenna size is accomplished by selecting different dimensions for the radiating elements and placing them inside each other in such away that they jointly form a rectangular spiral pattern.

FIG. 9g is a depiction for the space savings variation to the antenna of FIG. 9b in which the reduction in the antenna size is accomplished by choosing different dimensions for the radiating elements and placing them inside each other.

FIG. 9h depicts an antenna similar to the antenna of FIG. 9f in which the loop radiating elements are round and each of them has an angular length of 360 degrees. The loops jointly form a circular spiral pattern.

FIG. 9i depicts an antenna similar to the antenna of FIG. 9h wherein each of the radiating element loops has an angular length of 720 degrees. These loops jointly form a circular spiral pattern.

FIG. 9j depicts a dual-band antenna comprised of two antennas similar to the antenna of FIG. 9f, wherein the higher band portion of the antenna is placed inside the lower band portion.

FIG. 9k depicts left bottom portion of antennas as depicted in FIGS. 9f and 9j wherein, the capacitors C₁, C₂ and C₃ are inter-digital capacitors.

FIG. 9l depicts left bottom portion of antennas as depicted in FIGS. 9f and 9j wherein, the capacitors C₁, C₂ and C₃ are overlay capacitors.

FIG. 10 depicts a possible implementation for a gated-counter using J-K flip-flops and AND-gates.

FIG. 11a depicts a possible implementation for a staircase generator using two sample and hold circuits, an inverter, a voltage reference diode, four resistors and a FET switch.

FIG. 11b depicts a possible implementation for a staircase generator using 10 transistors. These transistors operate either in their cut-off or active regions.

FIG. 12 depicts the block diagram for a frequency stabilized, low distortion signal source system which is comprised of a staircase generator, a gated-counter, a dual feedback voltage controlled oscillator, a limiting amplifier and timer circuit.

FIG. 13a depicts one side of a key fob which include key blade and is attached to a fob. The key blade includes electrical contacts which can be used for providing RF signal to an external antenna, recharging the battery inside fob and electronic authentication for theft prevention. A touch pad is provided for authentication. Three buttons are provided for activation of a garage door.

FIG. 13b depicts a possible implementation for a second one side of a key fob which include key blade as described in FIG. 13a. Three buttons and an LED are provided for remote entry system.

FIG. 13c depicts a similar key fob to the implementation of FIG. 13b with the addition of a button for remote “START” of ignition of the vehicle.

FIG. 13d depicts an implementation of a key fob similar to FIG. 13a, wherein the biometric touchpad is replaced with an additional row of three buttons

FIG. 13e depicts a key fob, wherein the buttons on FIGS. 13a and 13b are implemented on one side of the fob.

FIG. 13f depicts a key fob, wherein the buttons on FIGS. 13c and 13b are implemented on one side of the fob with additional “ENGINE START” buttons.

FIG. 13g depicts a key fob, which includes an RLV (Recent Location of Vehicle) unit.

FIG. 13h depicts a key fob, which includes an RLV and a UT (Universal Transmitter), i.e., an RKE and a UGDO transmitter.

FIG. 13i depicts a key fob, which includes an RLV and a UT and the RLV includes a voice recording and playing device.

FIG. 14a depicts implementation of a combined transmitter unit on a fob which includes three buttons for RKE remote entry system, three buttons for activation of a UGDO (universal garage door opener), two buttons for disabling the garage door opening function, a touch pad for user authentication and an LED.

FIG. 14b depicts implementation of a combined transmitter unit on a fob which includes three buttons for RKE remote entry system, six buttons for activation of a UGDO (universal garage door opener) as well as code entry for user authentication in order to enable garage door function, two buttons for disabling the garage door opening function and an LED.

FIG. 14c depicts a fob, which includes an RLV (Recent Location of Vehicle) unit.

FIG. 14d depicts a fob, which includes an RLV (Recent Location of Vehicle) unit and a voice recording and playing units.

FIG. 15a depicts an implementation UT which is put on visor which row of three buttons for the activation of the UT and a touch pad 603 as an interface for the authentication hardware.

FIG. 15b depicts an implementation UT similar to FIG. 15a, wherein the touch pad is replaced by a secondary row of buttons.

FIG. 16a is an implementation of the present invention, wherein identical set of buttons, LED and touchpad as the implementation of FIG. 15a are implemented on overhead console.

FIG. 16b is an implementation of the present invention, wherein identical set of buttons and LED as the implementation of FIG. 15b.

FIG. 17a is an implementation of the present invention, wherein identical set of buttons, LED and touchpad as the implementation of FIG. 15a are implemented on the outer frame of a rearview mirror.

FIG. 17b is an implementation of the present invention, wherein identical set of buttons and LED as the implementation of FIG. 15b are implemented on the outer frame of a rearview mirror.

FIG. 18 is a block diagram of an ignition key with a fob in which several embodiments of the present invention are realized, i.e., a UT, an extra antenna, an RLV, an authentication biosensor, and a theft protection system is implemented.

### DESCRIPTION OF THE PREFERRED EMBODIMENTS

The present invention utilizes time domain for evaluating the frequency of a reference transmitter during the training procedure. In a preferred embodiment of the present invention, high speed sampling and digital to analog conversion is used to determine the frequency of the reference transmitter. In another preferred embodiment of the present invention a gated-frequency counter is utilized which is enabled only during the presence of a portion of a signal burst in order to determine the frequency of the reference transmitter. Both methods provide highly accurate frequency measurement which is essential for the maximum range when the transmit signal is generated.

The present invention refers to (UT) Universal Transmitter, regardless of whether it is used only as a universal transmitter device for garage door opening function (UGDO), remotely starting engines, turning on/off lights, remotely opening doors or used only as a universal transmitter device for remote keyless entry (RKE), or a device which functions as both.

According to the present invention, all types of devices i.e., RLV, UGDO and RKE can be implemented separately, or implemented as a combined device which is implemented on a fob or as a part of car key.

Similarly, a universal remote keyless entry (URKE) device can be made which can learn the code and the frequency of an existing RKE. This would be used as a replacement fob for users of keyless remote entry systems. As a convenient addition to an RKE or a URKE transmitter module, a display such as an LCD is added to the fob or the ignition key or other key fobs (e.g., door key, trunk key) for displaying the location where the vehicle is parked. The location information is supplied by the GPS receiver which is available in the vehicle either by wireless means or via contacts on the ignition keys. This information is provided to the operator by a display such as LCD or a built-in voice synthesizer.

According to some of the embodiments of the present invention for theft prevention, the UT's are equipped with authentication devices such as bio-sensors, microphones, keypads, etc.

According to a preferred embodiment of the present invention, numerical signal generation is utilized which produces nearly perfect sine waves that are inherently harmonic free, as opposed to a square wave or compressed sine waves produced by ordinary analog VCO's which contain excessive harmonic contents. Generation of “near perfect sine wave” is achieved by use of high speed solid state circuit technologies e.g., SiGe, BICMOS, GaAs, HBT and high speed CMOS which has become available at remarkably lower costs in the recent years. In another preferred embodiment, the present invention utilizes a DDS for generation of near perfect sine wave signal.

The present invention requires a very simple filtering scheme for suppressing the minimal amount of distortion available in dual feedback VCO's or the quantization noise and the distortion produced by nonlinearity of digital to analog converters which are several orders of magnitude smaller than those of compressed waveforms produced by typical VCO's. Therefore, a simple filtering scheme suffices to suppress the quantization noise which has typically very low magnitude and is a few octaves away from the corner frequency of the filter. The harmonic distortion is produced as a result of non linearity of digital to analog converter is typically very low in power. Hence, there is no need for any filters that roll-off in certain portions of the band and a programmable bandpass filter is sufficient and the maximum range is obtained for every user.

Another major advantage of techniques used in the present invention is that the same device could be used in a variety of bands (i.e. 25-40 MHz band and 200-450 MHz band) and modulation types when DDS or numerical oscillator are used as the means for generating the transmit signal. The modulation characteristics of the reference transmitter, i.e., AM or FM and its index is evaluated numerically without requiring different hardware e.g., frequency discriminators. Likewise, since signal modulation during transmitting is done numerically, separate hardware for different bands or modulation types are unnecessary.

### FM (FSK) Systems

Some of garage door openers in the market utilize FSK (frequency shift keying which is the digital form of frequency modulation in which the base-band is binary signal) as the modulation scheme. In order to detect FSK signals, any of the varieties of frequency demodulators can be utilized. A preferred method of demodulation is utilizing a delay line discriminator. In a delay line discriminator the FM signal is fed into a power splitter where one branch feeds the phase detector and the other branch connects to a delay line providing a 90 degree phase shift at the center frequency.

Delay line discriminators have a wide linear region for demodulation and are used in this invention for two purposes:
(1) Obtaining the baseband code.
(2) Estimate the index of modulation of the reference transmitter.

In order to achieve linear demodulation at various portions of the UT band a bank of delay lines are used. The carrier frequency is determined by the gated-counter or DFT/FFT procedure. Based on the carrier frequency (determined by the gated-counter or DFT/FFT procedure), the proper combination of delay lines are selected so that the carrier frequency falls at or near the center frequency of the discriminator which has high linearity. As a result of linear demodulation, the calculated index of modulation has high accuracy.

The operation of delay line discriminator is based on the fact that:

(1) A delay line provides a linear phase shift which is linearly proportional to frequency.

(2) A phase detector is fed with a reference signal at one of its ports and a delayed version of the same signal which is obtained by passing through a delay line. The phase shift is linearly proportional to frequency. Hence depending on the characteristics of the phase detector, the output voltage at the phase detector is related to the input frequency of the discriminator.

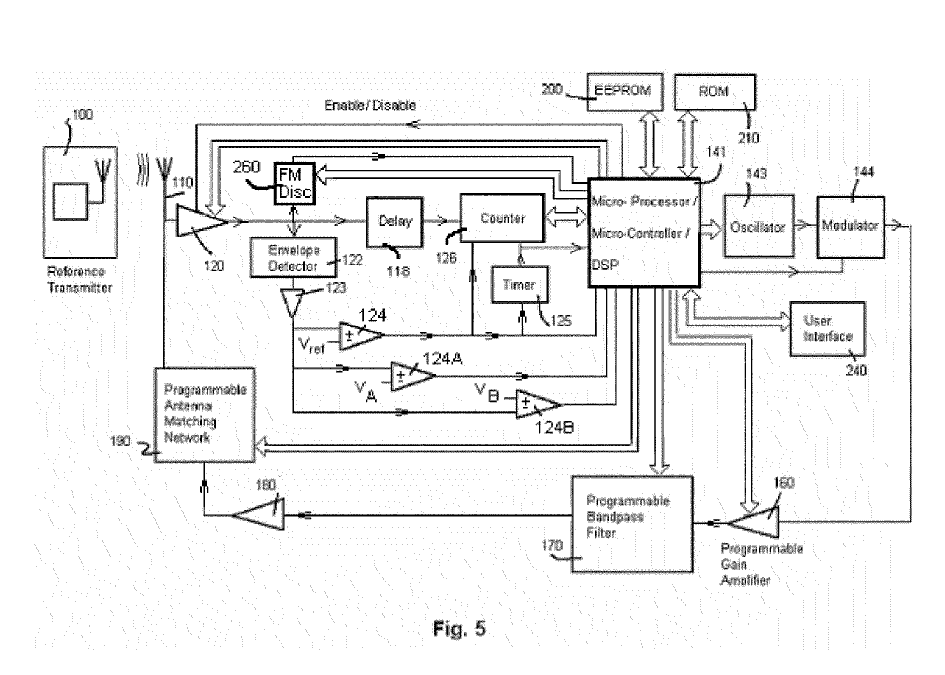

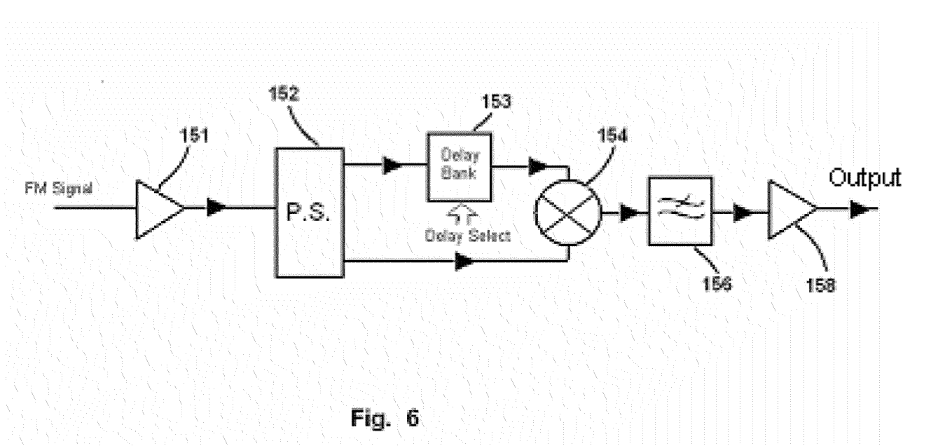

FIG. 6 depicts a possible implementation for a delay line discriminator wherein, an input signal is fed to a limiting amplifier 151. The limiting amplifier is utilized to provide a standard signal level to the phase detector regardless of the signal strength received by the UT. The output of limiting amplifier 151 feeds the power splitter 152. One of the output ports of power splitter 152 is fed into a delay line bank 153 which in turn feeds one of the inputs of phase detector 154. The other output of the phase detector 152 feeds the phase detector 154. The output of phase detector 154 is fed into a lowpass filter 156 which removes the undesired high frequency contents present at the output of the phase detector. The output of the lowpass filter 156 is amplified by the baseband amplifier 159 which is converted to a digital signal by A/D converter 162 which is the appropriate signal format for each implementation UT implementations to be processed by a digital processor (141).

Possible phase detector circuits are phase frequency detectors that are comprised of flip-flops and provide a linear relationship between phase difference of the signals at its input and the output voltage. Use of phase frequency detector is the preferred embodiment for the present invention due to its high linearity.

As discussed bellow, the frequency discriminator of FIG. 6 is utilized with “implementation 2” and “implementation 3” and in both cases the inputs are connected to the output of amplifier 120 and its output feeds the processor 141.

In an alternate method, the frequency discrimination (demodulation) as depicted in the frequency discriminator of FIG. 6 can be implemented in software utilizing a high speed DSP or other types of processors.

### Harmonic-Less Signal Generation

To avoid problems associated with high order filtering of the octave wide source required by the UT, the present invention utilizes low distortion sources which are referred to as distortion-less sources. Due to narrow bandwidth of garage door opener receivers (typically, 1-2 MHz) the frequency of transmitter oscillators have to be highly stable with temperature and aging.

According to the present invention, any of the 3 possible techniques are usable for the implementation of the signal source which meets the requirements of high stability, low distortion and wide bandwidth. These techniques are Numerical Signal Generation (NSG), Direct Digital Synthesis (DDS) and Dual Feedback VCO Frequency Stabilized by a Gated-Counter.

### Numerical Signal Generation

A high speed processor (microprocessor, DSP or FPGA) is utilized to produce a sinusoidal signal. Since economically feasible processors operate at lower frequencies required to be generated by a UGDO (i.e., 400 MHz), the data produced by the processor produced in a parallel format and then is fed to a demultiplexer and subsequently to a DAC which generates the analog signal. In order to have low distortion, a minimum of 10 bits has to be utilized otherwise the quantization noise and distortion would be excessive.

### Signal Generation by Means of Direct Digital Synthesis

According to this preferred embodiment of the present invention, Direct Digital Synthesis (DDS) technique is utilized for generation of sinusoidal radio frequency signal to be used as the transmitter signal source. The waveform is directly generated by using certain digital technique which is fundamentally different from the PLL based synthesizer technique. This method operates by storing the points of a waveform in a digital format and then recalling the stored data for generating the waveform. The rate that the synthesizer completes one cycle of the waveform constitutes the frequency of the output signal, i.e., while the rate of production of data is constant, the fewer number of data points used for construction of one cycle varies.

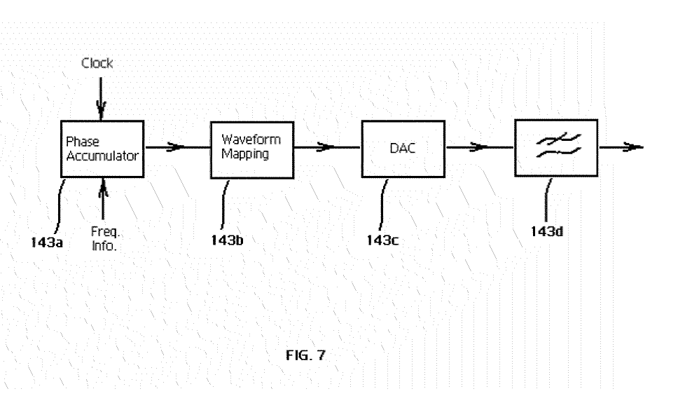

FIG. 7 depicts a typical block diagram of a DDS signal generator. The phase accumulator 143a has two inputs, a constant clock signal and frequency information which basically constitutes the phase increment. As the phase of the generated signal advances, the number in the accumulator increases. Once phase of the signal reaches 360 degrees the number corresponding the phase in the accumulator resets to zero. Smaller increments in the accumulator correspond to longer time for completion of a full cycle and consequently longer period or a lower frequency. As the frequency increases the phase increments get larger and less number of points on one cycle of the waveform is utilized. As a result, for higher frequency signals, there is going to be more distortion and harmonics.

According to FIG. 7, the phase accumulator 143a is followed by waveform mapping 143b which can be a ROM or a PROM and it is followed by Digital to Analog Converter (DAC) 143c, followed by lowpass filter 143d. The number corresponding to the phase of the signal is stored in the phase accumulator. As the phase of the signal advances, the number corresponding to phase in the phase accumulator increases. The output of phase accumulator 143a is fed to waveform mapping 143b which produces a number corresponding to a point on the sine wave waveform. This number is converted to a voltage by the DAC 143c. The lowpass filter 143d suppresses the unwanted signals, i.e., there are spurious signals generated by DDS, i.e., the alias signals which are the images of the signal on both sides of the clock frequency and its multiples. The major advantage of DDS is that there is no need to wait for the synthesizer to settle as it is necessary to wait for the settling time in the phase-locked loop based synthesizers.

### Frequency Stabilization Technique for VCO's

According to this preferred embodiment of the present invention, a special type of voltage controlled oscillator (VCO) which has dual feedback and produces low harmonic distortion in combination with a gated-frequency counter and a staircase generator circuit are utilized to function as the signal source for transmitter. The gated-frequency counter in and a staircase generator are added to the VCO for frequency stability. Upon pressing a button on the UGDO, the staircase generator produces a plurality of voltages in the expected range for producing the desired frequency. These voltages are successively fed to the VCO which in turn produces signals with frequencies in the desired frequency range. The gated-counter measures the frequency of the VCO at every step. Once the desired frequency is obtained, the staircase generator stays on that voltage, and subsequently, the signal is as the transmitter signal.

### Prior Art VCO's

The ordinary VCO's (voltage controlled oscillator) which are commonly used in different applications are not appropriate for use in the present invention since they produce harmonics which cannot be suppressed in a consistent and repeatable fashion. Use of a varactor diode in conjunction with the inductance of the antenna in order to implement a tunable resonator tuned by a DAC as is utilized in the prior art is not suitable and not repeatable nor reliable. Varactor diodes' capacitances versus voltage characteristics are not repeatable and also their changes with temperature are quite significant. As a result, transmitters which incorporate a varactor in a resonator in order to allow the fundamental and suppress the harmonics are prone to significant statistical variations and temperature changes which result in drop in the amplitude of fundamental due to off-tuned operation of the resonator.

In an ordinary VCO, there is excessive amount of harmonic content which is produced as a result of uncontrolled signal growth for the positive feedback loop pushing the signal to amplitude saturation, i.e., as the amplitude of the sinusoidal oscillation grows and eventually the sine wave gets compressed resembling to a square wave containing excessive harmonic contents. Filtering these harmonics is a tedious (if not impossible) task. As, VCO's which are used in UGDO's are an octave wide. The second harmonic of the lower portion of the frequency range of UGDO (200 MHz) falls on its high end. Implementation of any filtering scheme for reducing the second harmonic at that high end of the band (˜400 MHz) also reduces the signal when its fundamental frequency is at the high end of the frequency band.

### Dual-Feedback VCO's

According to this preferred embodiment of the present invention, a second feedback loop is utilized in conjunction with a VCO. The second loop provides a negative feedback for the amplification mechanism in such a way that controls the amplitude growth and consequently prevents the signal from getting compressed. This is done by keeping the signal amplitude at a certain level which is not compressed and therefore is distortion free.

A possible method for implementation of the special type of VCO with a second feedback loop, “dual-feedback VCO” is explained bellow. A positive feedback loop is used for producing the RF oscillations and a second feedback loop is used to keep the amplitude of the signal at certain intermediate level. The second feedback loop prevents the signal from becoming saturated and maintains its sinusoidal shape.

The second feedback loop can be added to any type of VCO's, e.g., VCO's which work on the principle of the signal form the output port feeding back to the input port as well as VCO's which work on the principle of negative resistance.

The methodology for implementation of “dual-feedback VCO” is by sensing the amplitude of the output circuit using an amplitude detector circuit. When the amplitude reaches certain level, the second feed back loop is activated to lower the amount of positive feedback of the VCO. This is done by reducing the oscillator's loop gain (forward gain times the feedback) or by reducing the magnitude of negative resistance. As a result, the output signal stabilizes at a desirable level and maintains a sinusoidal waveform.

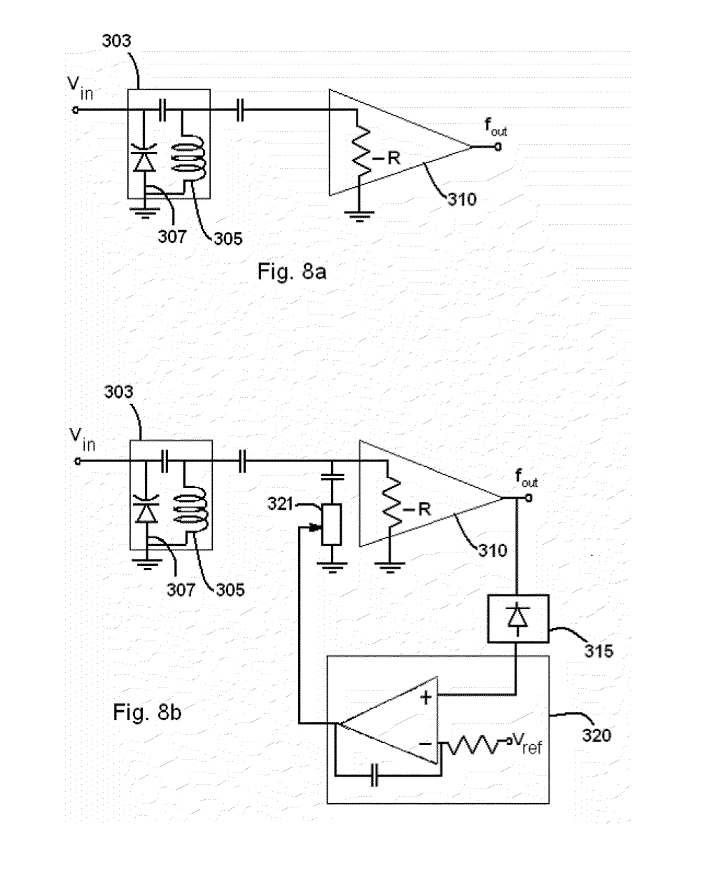

FIG. 8a depicts a block diagram of an ordinary VCO which its output is a distorted sine wave. This implementation of ordinary VCO is based on negative resistance (negative resistors are commonly implemented by utilizing an amplifier with a positive feedback. According to this figure, negative resistor 310 is coupled to tank (resonator) circuit 303 which is comprised of varactor diode 307 and inductor 305. Signal is initiated in the circuit by thermal/shot noise. The initial signal is amplified upon reflection by negative resistor 310. The amplification of signal when reflected by a negative resistance is explained by equation (5). Negative values for load impedance Z_{L} yields voltage reflection coefficient with magnitudes of greater than unity (|┌|>1):

$$Γ = \frac{{Z}_{L} - {Z}_{0}}{{Z}_{L} + {Z}_{0}} \qquad ( 5 )$$

Reflection coefficients of larger than unity correspond to voltage gain. After reflection from the negative resistance with voltage gain, the signal is incident on the tank circuit 303. The tank resonators in the vicinity of their resonance frequency exhibit a sharp transition of the phase reflection coefficient versus frequency characteristics. The process of signal reflection and amplification is continued. Oscillation is established at the frequency which the resultant phase-shift from reflections from the tank circuit plus the negative resistance is 360 degrees and the loop gain is greater than one. Since loop gain is greater than one, the magnitude of signal keeps growing until the signal cannot grow any further which is being restricted by power supplies voltages and compresses and the point the large signal loop gain is unity.

FIG. 8b depicts a possible implementation for the block diagram of a dual feedback VCO which produces low distortion sinusoidal signal and contains a VCO similar to the one in FIG. 8a and also includes an additional feedback loop for providing negative feedback for amplitude control mechanism. A similar amplitude control mechanism can be applied to other types of VCO's which utilize techniques other than negative resistance.

According to FIG. 8b the output of amplifier 310 is connected to an amplitude detector circuit 315 which feeds comparator-integrator circuit 320 producing a ramp function which its slope is proportional to the difference between the detected voltage and a reference voltage V_{ref}. The output of comparator-integrator circuit 320 is connected to a voltage-controlled resistor 321 connected in series with the negative resistor −R. The negative resistor −R is represented as a part of amplifier 310 which is constructed by some sort of positive feedback. In order to prevent bias disruption DC blocking capacitors are utilized where necessary. Possible devices which can be used for voltage-controlled resistor 321 are a FET, a (PIN) diode in conjunction with a series resistor, a BJT or any other types of device which exhibits different resistance as its input voltage/current is changed. When the detected voltage is less than V_{ref}, a negative voltage ramp is generated by comparator-integrator 320 feeding voltage-controlled resistor 321 and as a result 321 is in cutoff mode and doesn't play any role and the VCO performs its normal operation. However, when the detected voltage becomes greater than V_{ref}, a positive voltage ramp is generated by comparator-integrator 320 feeding voltage-controlled resistor 321. As the voltage on the input of voltage-controlled resistor 321 increases the resistance of its output is decreased. Consequently, the effects of negative resistance −R is decreased which impedes the amplitude growth of the RF signal produced by the VCO. Eventually, the amplitude at the output of VCO is stabilized at a point where the detected voltage at the output of detector 315 equals V_{ref} and there is no voltage difference on the inputs of comparator-integrator 320, consequently the slope of the output voltage of comparator-integrator 320 with respect to time is zero. The appropriate selection for V_{ref} is essential in order to obtain a low distortion sinusoidal signal.

### Gated-Counter

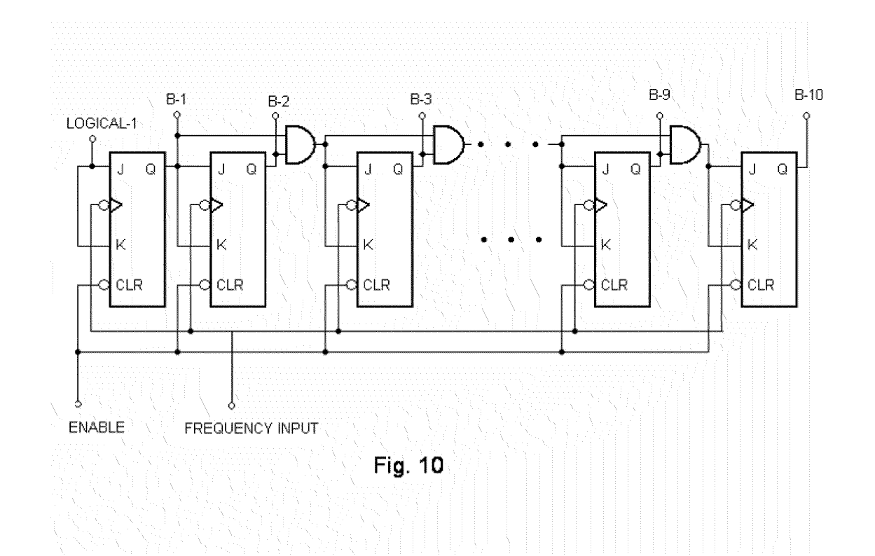

A gated-counter circuit measures the number of sinusoidal zero crossings or transitions in a square wave during a selected window of time in order to determine the frequency. The requirement for the counter is handling the speed of 450 MHz and high resolution e.g., 10 bits. A possible implementation for such a counter using J-K flip-flops and AND-gates is depicted in FIG. 10. Other possible techniques for implementation of the gated-counter with similar function include use of different hardware, e.g., FPGA's, or different types of flip flops

### Staircase Generator Circuits

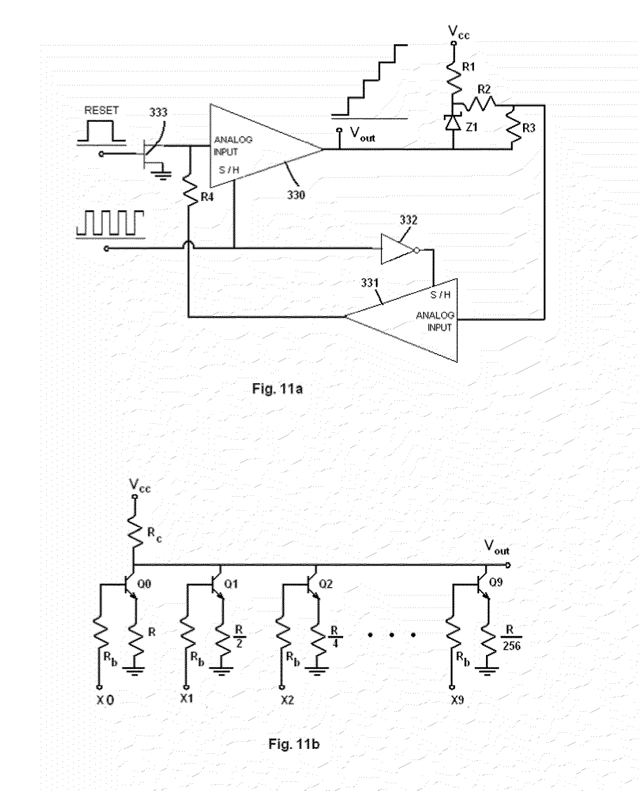

FIGS. 11a and 11b depict two possible implementations for a staircase generator circuit. According to the implementation in FIG. 11a, two sample and hold circuits 330 and 331 are utilized. A square wave is fed to the input of S/H (sample and hold) 330. The square wave is fed to inverter 332 and its output feeds the S/H input of 331. The output of 330 is connected to the positive supply (designated as Vcc) via Zener diode Z₁ and resistor R₁. A voltage divider comprised of R₂ and R3 circuits produces a voltage Δv which is a fraction of the Zener voltage. This voltage corresponds to the step size for the staircase waveform. The tapping point on the voltage divider is fed to the analog input of S/H 331. The output of 331 is connected to resistor R₄ which is in turn connected to the analog input of 330. FET switch 333 is connected between ground and the analog input of 330.

As a reset signal, i.e., logical-1 pulse is applied to the gate of 333, the circuit is initialized, i.e., the analog input of S/H 330 is zeroed. When the gate voltage is lowered to a logical-0, FET switch 333 is disabled and it does not have any effects on the circuitry. After resetting, the output of S/H 330 (Vₒᵤₜ) is at zero. Subsequently, the output of voltage divider is set at Δv. During the sample period of S/H 330 which corresponds to the hold period of S/H 331 (the output of inverter 332 is logical-0), the voltage Δv is sampled by S/H 331. Subsequently after the transition of logic, a voltage of Δv is held at the output of S/H 331 and during the same time (logical-0 for S/H 330), the voltage Δv is present at the input of S/H 330 and is sampled by S/H 330. Upon the next transition, Δv is held at the output of S/H 330 yielding a voltage of 2Δv on the output of voltage divider. Similarly, on every full clock cycle, before the saturation voltage is reached, the voltage Δv is added to the previous value of Vₒᵤₜ which results in generation of staircase waveform at the output of S/H 330.

In an alternative method depicted in FIG. 11a, NPN transistors Q0 through Q9, (operate in their active or cutoff regions) are hooked up to the same collector resistor marked as R_{c}. The collector resistor R_{c} is connected between Vcc and the collectors of all the transistors Q0 through Q9. Each transistor is connected to a separate base resistor and a separate emitter resistor. Every base resistor is connected between data input port and the base of the transistor and has the same value R_{b}. The emitter resistors connected between the emitter and ground and are marked with their values of R, R/2, R/4, . . . , R/256. The values of resistors are selected in such a way that when a logical-0 is applied to a base resistor of any of the transistors, the transistor operates in the cutoff region and when a logical-1 is applied to a base resistor of any of the transistors, the transistor operates in the active region. This is for all the possible combinations of input logic. When any of the transistors operate in its active region, the collector current is proportional to the inverse of their emitter resistance, i.e., 1/R, 2/R, 4/R, . . . , 256/R or equivalently, 1, 2, 4, . . . , 256. Application of logic X0 on the base resistor of Q0 produces the least change in its collector current while application of logic X9 on the base resistor of Q9 produces the most significant change in its collector current. Thereby, when a 10-bit parallel data stream (X0, X1, . . . , X9) is applied to base resistors, 2¹⁰=1024 different currents are produced. For every possible current passing through R_{c}, a voltage is produced which corresponds to one of the 1024 different output voltages.

### Frequency Stabilized VCO by Use of Gated-Counter & Staircase Generator

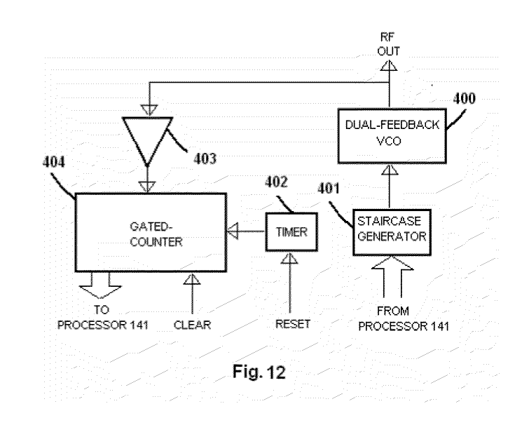

FIG. 12 depicts the block diagram for a frequency stabilized, low distortion signal source system. The system is comprised of staircase generator 401, dual feedback voltage controlled oscillator 400, limiting amplifier 403, gated-counter 404 and timer circuit 402. Staircase generator 401 has input ports for receiving control signal from a controller device such as a micro-controller. The output of staircase generator 401 is fed to dual feedback VCO 400. The RF output of VCO 400 which is the system output is also fed to limiting amplifier 403 and gated-counter 404. Timer 402 which is set by a micro-controller device, outputs highly accurate timing window signals to gated-counter 404. A possible implementation for timer 402 is circuitry comprised of a precision frequency source (e.g., a crystal oscillator) and counter, wherein the counter is reset at the beginning of the time window, and after certain number of counts, the counter outputs the timing signal to indicate the end of the time window.

The principle of operation of this method is based on finding the appropriate voltage level produced by staircase generator for which when voltage is supplied to the VCO, the desired frequency is produced. Different search methods for finding this voltage can be used. When a staircase generator such as the staircase generator of FIG. 11a is used for the block 401, the voltage at the output of 401 is successively increased in small steps producing different frequencies at the output of VCO 400. Limiting amplifier 403 converts the sinusoidal signal produced by VCO to square wave with the appropriate amplitude for the gated-counter 404. At every voltage step, the frequency is determined by counting the number of signal transitions in the time window set by timer 402. A time-efficient algorithms can be utilized to find the appropriate voltage for the generating the desired frequency. For example, the search can be done by use of two points and extrapolation or interpolation successively until the target frequency is reached.

### Antenna

As discussed in the background section, the prior art UGDO's use narrowband varactor-diode-tuned antenna. As explained previously, the capacitance of varactor diodes are subject to temperature and statistical variations which causes mismatch losses in the transmit power which in turn causes loss of UGDO range. The present invention utilizes wideband tuning and thereby it is not subject to problems arising from capacitance changes of varactor diodes.

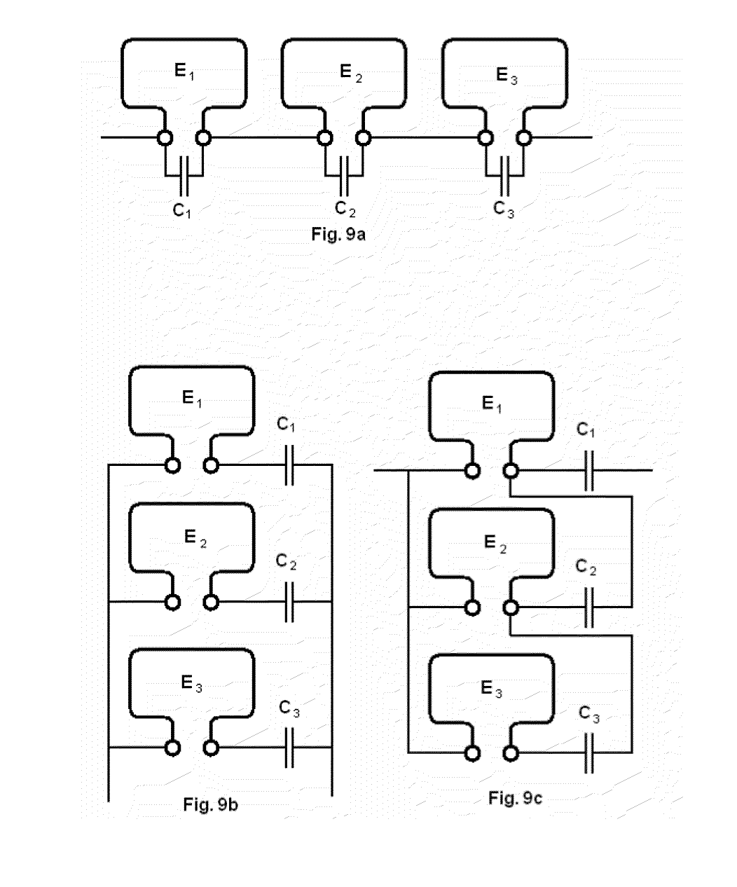

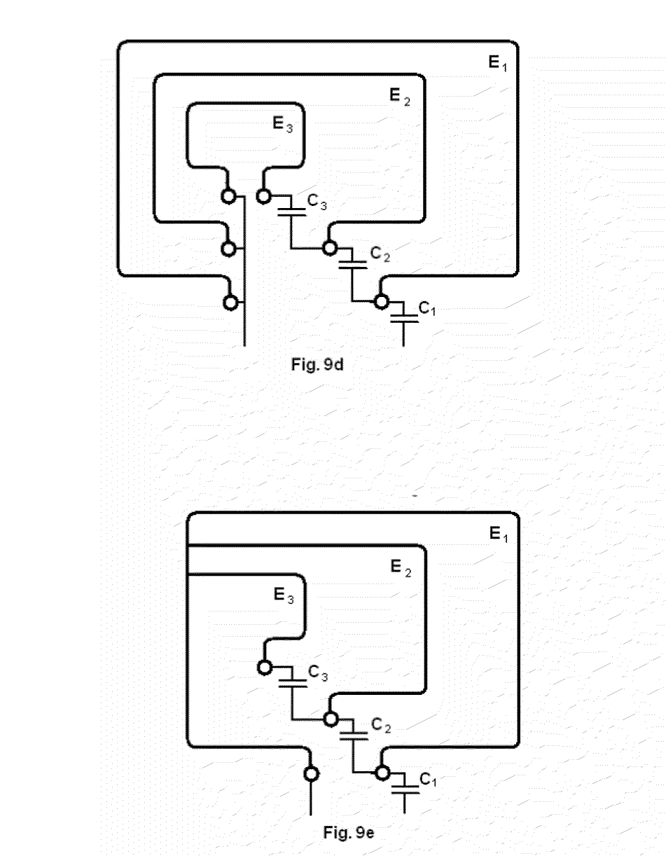

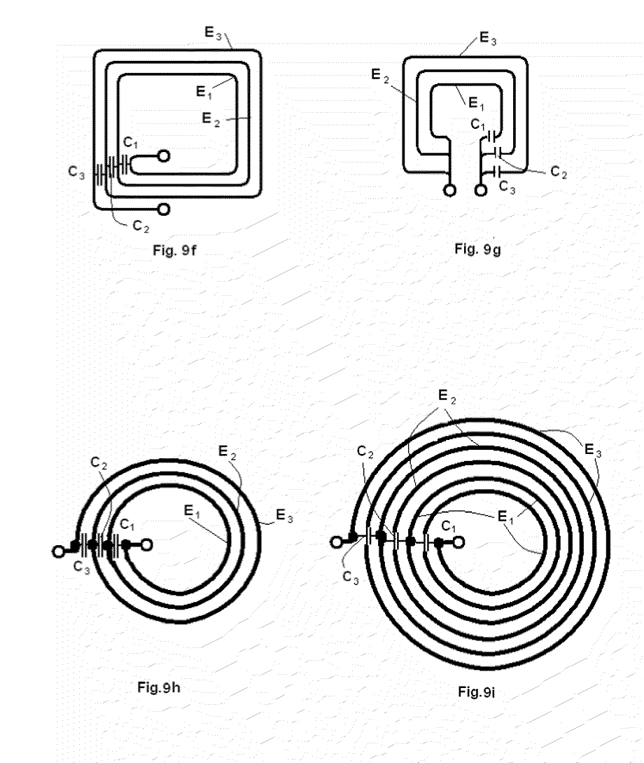

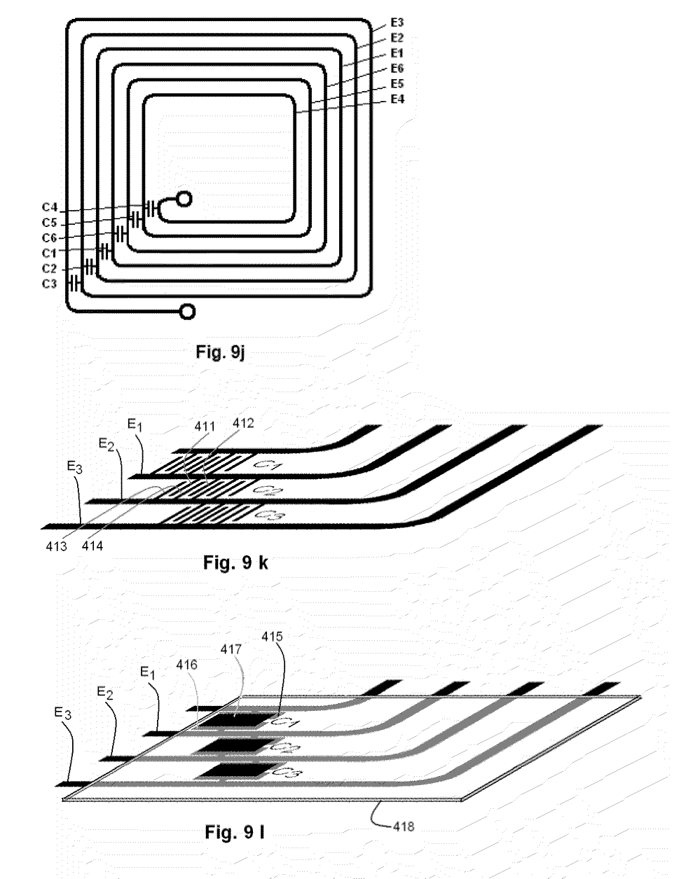

According to the present invention, new types of wideband antennas are implemented. The new antennas are comprised of multiple radiating elements with different resonant frequencies which mutually exhibit a wideband match/radiation. As a representative of the antenna concept, FIG. 9a depicts a possible implementation of a wideband antenna comprised of only three sections. Depending on the space availability for the antenna more number of sections can be used for obtaining better performances. The electrical performance of an antenna with a larger number of sections is more desirable, as more sections provide less ripple magnitude in the antenna impedance versus frequency characteristics.

In the antenna of FIG. 9a, each section is comprised of a two-port radiating loop referred to as a radiating element E. Each radiating element E has two different equivalent circuits:

(1) An inductor L in parallel with a large resistor R.

(2) An inductor L in series with a small resistor r.

In both cases R or r represent the total resistance of antenna which incorporates the effects of radiation resistance and the conductor and dielectric losses associated with the radiator.

According to a preferred embodiment of the present invention for implementation of a wideband antenna is comprised of a plurality of sections, wherein each section is comprised of radiating element E in parallel with a capacitor C, which they jointly produce a resonance at frequency f. At resonance, the susceptances are cancelled, and the resultant impedance of each section is finite impedance R.

Antenna theory predicts that, when multiple two-terminal radiators having parallel resonances at different frequencies when connected in series and impedance matched, jointly, they produce wider band than the total bandwidth from the sum of bandwidths produced from the individual resonators when impedance matched.

FIG. 9a depicts a possible configuration for a wideband flat antenna implementation which is suitable to be used in a UT as well as other applications for wideband antennas and is comprised of 3 two-terminal radiators having parallel resonances at different frequencies connected in series. As depicted in FIG. 9a, the radiating elements are made of small loops, i.e., their dimensions are much smaller than the quarter wavelength exhibiting inductive reactance, thereby requiring a capacitance to produce an impedance match at a resonance frequency. The first radiating element is designated as E₁ is connected in parallel with capacitor C₁. Similarly, the second radiating element E₂ is connected in parallel with capacitor C₂ and, the third radiating element E₃ is connected in parallel with capacitor C₃. The E₁-C₁, E₂-C₂ and E₃-C₃ are connected in series forming a wideband antenna as explained above. E₁ and C₁ produce a parallel resonance at frequency f₁, i.e., their admittances are cancelled and only the equivalent shunt resistance R₁ (total resistance of radiating element E₁ which includes the radiation resistance and the resistance which accounts for the conductor and dielectric losses) remains at resonance.

This is while the other resonators comprised of E₂∥C₂ and E₃∥C₃ are not at their resonant frequencies and exhibit impedances which are quite lower than the value of R₁. Thus, the three radiating elements of FIG. 9a in parallel with their capacitors provide the three narrow resonances at frequencies of f₁, f₂, and f₃. However, as explained above there are additional resonant frequencies produced as a result of mutual interactions between the three loops which produce a wide band of operation.

FIG. 9b is another possible configuration for a wideband flat antenna implementation suitable to be used in a UT as well as other applications. In this implementation each radiating element and its associated resonating capacitor are connected in series and the three resonators are connected in parallel. According to this figure, there are three small loop radiating elements. Each radiating element E (comprised of an inductance and a series resistance r which accounts for the radiation loss and conductor losses) is connected to a series capacitor C forming a series resonance.

FIG. 9c depicts a wideband “hybrid mode” (combination of series and parallel resonances) antenna, wherein the E₃ and C₃ are put in series producing a series resonance. The series combination of E₃ and C₃ are put in parallel with E₂ which they jointly are in series with C₂ produce a hybrid resonance. The combination of E₃, C₃, E₂ and C₂ are put in parallel with E₁ jointly produce another hybrid resonance.

FIG. 9d is the space savings variation to the wideband hybrid mode antenna of FIG. 9c. The reduction in the antenna size is accomplished by choosing different dimensions for the radiating elements E₁, E₂ and E₃ and placing them inside each other.

FIG. 9e is also a space savings implementation for a wideband hybrid mode antenna similar to the implementation according to FIG. 9d wherein portions of the radiating elements are shared.

FIG. 9f is the space savings variation to the wideband antenna of FIG. 9a. The reduction in the antenna size is accomplished by choosing different dimensions for the radiating elements E₁, E₂ and E₃ and placing them inside each other in such a way that they jointly form a rectangular spiral pattern. The capacitors C₁, C₂ and C₃ are respectively connected in parallel with the radiating elements E₁, E₂ and E₃. The connection is in such a way that each capacitor is placed at the two ends of its respective radiating element.

FIG. 9g is the space savings variation to the wideband antenna of FIG. 9b. The reduction in the antenna size is accomplished by choosing different dimensions for the radiating elements E₁, E₂ and E₃ and placing them inside each other. The capacitors C₁, C₂ and C₃ are respectively connected in series with the radiating elements E₁, E₂ and E₃.

FIG. 9h depicts an antenna similar to the wideband antenna of FIG. 9f in which the radiating elements loops E₁, E₂ and E₃ have curved shape and each of them has an angular length of 360 degrees. These loops jointly form a circular spiral pattern. The capacitors C₁, C₂ and C₃ are respectively connected in parallel with the radiating elements E₁, E₂ and E₃. The connection is in such a way that each capacitor is placed at the two ends of its respective radiating.

FIG. 9i depicts an antenna similar to the wideband antenna of FIG. 9h in which each of the radiating element loops E₁, E₂ and E₃ have an angular length of 720 degrees. These loops jointly form a circular spiral pattern. The capacitors C₁, C₂ and C₃ are respectively connected in parallel with the radiating elements E₁, E₂ and E₃. The connection is in such a way that each capacitor is placed at the two ends of its respective 720° radiating element with a conductor track under each capacitor. The number of turns could be variable, i.e., the inner loops can have more turns than the outer loops and the number of radiating elements can be more than 3 which was used as an example.

FIG. 9j depicts a dual-band wideband antenna which is comprised of two antennas similar to the antenna of FIG. 9f wherein the radiating element loops E₁, E₂ and E₃ are respectively connected in parallel with the capacitors C₁, C₂ and C₃ constituting an antenna for the lower frequency band. Similarly, the radiating element loops E₄, E₅ and E₆ are respectively connected in parallel with the capacitors C₄, C₅ and C₆ constituting an antenna for the higher frequency band. As illustrated in FIG. 9j, the higher band antenna is placed inside the lower band antenna due to the fact that the lower frequency-band antenna has bigger dimensions than the higher band antenna.

There are different choices for capacitors in the abovementioned antennas, such as chip capacitors, overly capacitors or inter-digital capacitors. When overlay capacitors are implemented, a second layer of dielectric material affixed to the first layer with appropriate metallization is used.

The antennas can be implemented on printed circuit board or flexible material such as Mylar®, cellophane or other flexible material such as plastic material with metallization. The choice of flexible material is made in order to save space by affixing the flexible antenna to the housing of UT.

FIG. 9k depicts a 3-dimentional view for a possible implementation of the left bottom portion of the antennas depicted in FIGS. 9f and 9j wherein, the capacitors C₁, C₂ and C₃ are inter-digital capacitors. In this depiction, each capacitor has 8 fingers, e.g., 411 and 412 are fingers of C₂ and connected to the inner side of the radiating element E₂, and 413 and 414 are fingers of C₂ and connected to the outer side of the radiating element E₂.

FIG. 9l depicts a 3-dimentional view for a possible implementation of the left bottom portion of the antennas depicted in FIGS. 9f and 9j wherein, the capacitors C₁, C₂ and C₃ are overlay capacitors. In this depiction, a dielectric layer 418 is added atop of the plane containing the radiating elements E₁, E₂ and E₃. Each capacitor is constructed by two rectangular conducting plates which are in the same plane as the radiating elements E₁, E₂ and E₃ and a rectangular plate on the top surface of dielectric layer 418, e.g., C₁ is comprised of rectangular conducting plates 415 and 416 which are in the same plane as the radiating elements E₁, E₂ and E₃ and 417 rectangular plate on the top surface of dielectric layer 418.

### User Authentication

Some garage door openers operate with rolling codes, i.e., to prevent copying and reproduction by an unauthorized person, the receiver does not respond to a code that was recently used and only responds to certain group of new “rolling” codes that are identifiable by the receiver circuitry. In order to accommodate the owners of such garage door openers, the prior art UGDO's also are adapted to handle rolling codes. However, adaptation of rolling codes into universal garage door openers is essentially contradictory to the main goal behind their utilization, i.e., rolling codes are implemented to prevent their reproduction by another device. As an example for a possible scenario, a parking attendant who has a temporary access to vehicles can utilize a prior art UGDO and train the UGDO to learn it and produce the rolling code from the GDO/UGDO and afterward use the UGDO to break in a gate or garage door which work with rolling codes. The availability of UGDO's which can learn rolling codes without any measures to safeguard GDO's/UGDO's from being copied gives a false sense of safety to the users of rolling codes.

This false sense of security is avoided by the use of the present invention. According to the present invention, in order to prevent copying of a code by another universal garage door opener, authentication devices and/or methods are utilized prior to transmission of a signal. Two possible scenarios for authentication procedures are:
(1) On every transmission an authentication procedure is required.
(2) UT is disabled by the users when the vehicle is left by potentially insecure persons. Also, when the user decides, he/she enables the UT by means of an authentication procedure.

Examples of authentication hardware are keypads for entering a code, biometric identification devices such as fingerprint sensors, voice recognition devices, etc, which are used according to the present invention. Voice recognition is implemented by adding a microphone and amplifier and A/D converter which in turn connects to a processor which contains voice recognition software. The voice recognition can be specific to user's/users' voice(s) or alternatively can be non-specific and just based on passwords uttered by different individuals.

According to the present invention, different prompts and messages are provided to the user by an LED. According to a preferred embodiment of the present invention, the synthesized voice provides the messages and/or voice prompts that the data for the voice could be either in phonetic format or prerecorded human voice which is digitized and stored in a memory device and upon the changes in the status of the device the appropriate message is played. This is done by connecting the processor to a D/A converter followed by an audio amplifier and a speaker. The voice messages/prompts played are such as “PLEASE ENTER YOUR PASSCODE”, “TO CONFIRM IDENTITY PLEASE TOUCH THE SENSOR”, “PLEASE WAIT, TRAINING IN PROGRESS”, “PLEASE HOLD THE TRANSMIT BUTTON ON THE REFERENCE TRANSMITTER WHILE HOLDING THE BUTTON WHICH YOU WANT TO SAVE THE CODE”, “TRAINING COMPLETED” or any other type of instructions.

In a preferred embodiment according to the present invention, when the remote keyless entry and/or universal garage door opener and are/is implemented on an ignition key, electrical contact points are implemented on the key blade in order to:
(1) Improve the signal path to the garage door opener receiver, by placing the UT antenna on windshield or on top area of a dashboard. The signal from the key is supplied from the contact points on the key blade to the windshield antenna via transmission lines such as coaxial or shielded balanced transmission line or miniature cables.
(2) Recharge the battery in the key fob
(3) Avoid vehicle theft by reading code from the key fob.

### Universal Transmitter Systems Implementations

In order to demonstrate various embodiments of the present invention, three different implementations of the present invention are presented below. These implementations are exemplary and are not the only possible schemes. It is possible that the combination of the features from two or three implementation be utilized in order to realize a UT. The antennas in all three exemplary implementation are referred to as 110 which could be any of the antennas as described herewith and depicted in FIGS. 9a, 9b, 9c, 9d, 9e, 9f, 9g, 9h, 9i, 9j, 9k and 9l. For UT implementations which accommodate both North American as well as European bands, a dual mode antenna such as depiction of FIG. 9J is used. However, FIG. 9J is only a representative concept and similar antennas with more turns or round spiral can be utilized. The oscillators referred to as 143 are according to the above preferred embodiments which are of then types with low distortion and high frequency stability, i.e., a Frequency Stabilized VCO by use of Gated-Counter and Staircase Generator, a DDS system or a numerical signal generator.

### Universal Transmitter Implementation 1

In this implementation, high speed sampling is used for acquisition of the signal from a reference transmitter. By means of a demultiplexer the received data is converted into parallel format which has a lower speed and can be handled by a low cost processor. The receiver gain is controlled and adjusted by the processor such that the adequate number of bits is utilized. The processor determines the bit pattern and obtains the frequency of the signal of reference transmitter by use of Discrete Fourier Transform (DFT) or Fast Fourier Transform (FFT) and subsequently the frequency, code, modulation information are stored in a memory device. The transmit signal is produced by retrieval of the information from the memory device which are subsequently processed by a multiplexer and converted to the high speed and subsequently analog format with optimized level. Based on the frequency a band pass network for harmonic reduction and a matching network for the optimum power are selected.

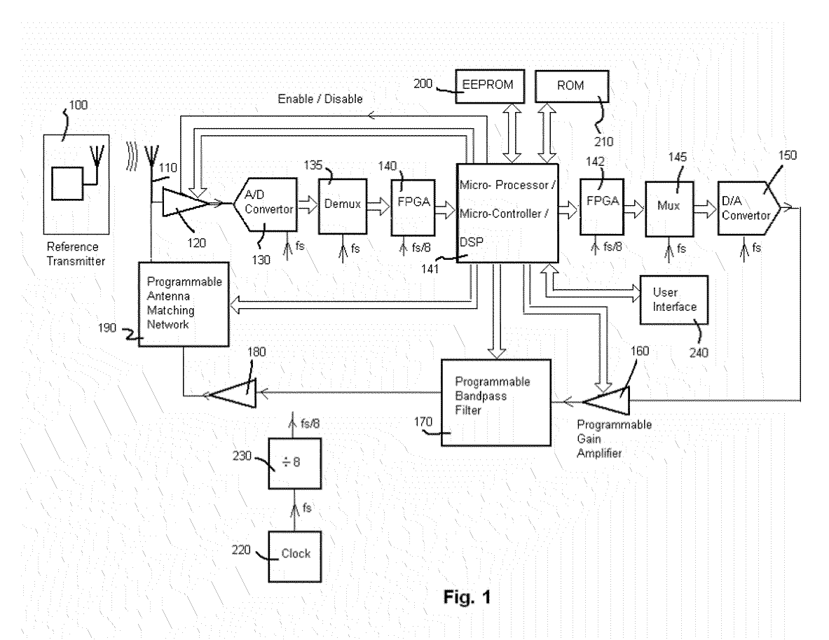

FIG. 1 depicts a possible embodiment of this implementation of the present invention. In this implementation, antenna 110 is followed by: programmable gain amplifier 120, high sampling rate analog to digital converter 130, demultiplexer 135, FPGA 140, processor 141. FPGA 140 functions as a FIFO (First In First Out) buffer which is utilized for data speed adjustments. Processor 141 could be a microprocessor or a microcontroller or a digital signal processor (DSP) or another FPGA or portions of FPGA's 140 and 142 can be used as the processor. Processor 141 is connected to two memory devices EEPROM 200 and ROM 210. EEPROM 200 is used for storing information obtained by UT and ROM 210 contains the program which runs the UT. Processor 141 is followed by FPGA 142 which also functions as FIFO memory and is followed by multiplexer 145, high speed digital to analog converter 150, programmable gain amplifier 160, programmable band pass filter 170, amplifier 180 and programmable matching network 190, connected to the antenna 110. Programming antenna matching network 190 is simply comprised of various reactive networks. Based on the frequency of the signal to be transmitted for obtaining a near optimum match to the antenna a combination of these networks are inserted in accordingly.

The user interface 240 contains an LED, a plurality of buttons and authentication hardware as discussed above. Each button can be used for a different gate or garage door or other use. The user interface 240 also includes an LED which is turned on at various events:
(1) To indicate the activation of transmitter as a button is pressed.
(2) Blinking at different rates in order to inform the user about the different stages of training procedure while, e.g., training in progress, training completed, etc. The LED's are located on the interface circuit 240 and are connected and controlled by the processor 141.
(3) Blinking at a very slow rate indicates that an authentication is required.

Alternatively, an LCD could be used to inform the user about the various events and prompts.

In an alternative embodiment voice prompts inform the user about the status of device, the user interface includes a D/A converter, and an audio amplifier which in turn feeds a speaker.

According to a preferred embodiment of the present invention the Universal transmitter (UT) includes user authentication features, one of the following hardware are implemented:
(1) Bio-sensors, e.g., touch pads for sensing fingerprints
(2) Microphones, used for voice recognition
(3) Keypads, i.e., several buttons for entry of a pass code for, e.g. 6 buttons which could also function for other purposes.

The clock 220 provides the sampling frequency fₛ feeding the A/D converter 130, demultiplexer 135, multiplexer 145, and D/A converter 150. The divide-by-eight circuit 230 divides the clock frequency providing a clock frequency of fₛ/8 to FPGA's 140 and 142.

### Training Mode

During training mode the UT learns the frequency and the code of a reference transmitter. The reference transmitter is brought close to the UT and the transmit button on the reference transmitter and one of UT buttons (located on user interface 240) are pressed simultaneously. If already there is a code and a frequency saved in the memory associated button previously, after certain period of time, e.g., 10 seconds the processor stops transmitting. However, when the memory associated with that button is blank, the training procedure starts immediately. The training procedure is as follows.

The signal transmitted from the transmitter 100 is received by antenna 110, which is amplified by amplifier. The output of the amplifier 120 feeds a high speed analog to digital converter (ADC) 130. A frequency of 1.6 GSPS (Giga sample per second) is an appropriate choice for clock sampling frequency (fₛ).

The data at the output of analog to digital converter (ADC) 130 are fed to demultiplexer 135 which converts the high speed data (fₛ=1.6 GSPS, 10 bits/sample) at the output of ADC 130 to a lower speed 8 parallel ports at 200 MSPS per port data streams. Demultiplexer 135 lowers the data rate by converting a high speed data stream into 8 parallel streams which are sufficiently slow to be handled by FPGA 140. DDR (Double Data Rate) SDRAM (Synchronous Random Access Memory) 220 in combination with FPGA function as a FIFO shift register and the collected data are fed to processor 141 which could be a Micro-Processor/Micro-Controller/Digital Signal Processor (DSP) or another FPGA.

Processor 141 analyzes the data and determines the frequency spectrum, the modulation scheme and the code of the reference transmitter 100. The carrier frequency is evaluated by utilizing a form of DFT/FFT. Based on the frequency spectrum, the modulation type is determined. Subsequently, the code is determined by a software algorithm, e.g., a DSP method can be used for demodulating AM or FM signals or alternatively, special hardware for detection.

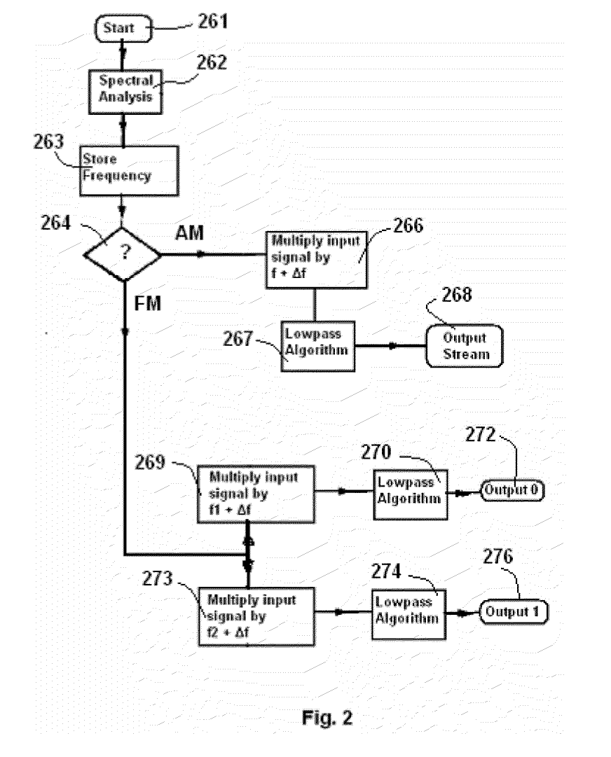

FIG. 2 depicts the flow chart for operation of processor 141 used in the UT according to the present invention in relation to this implementation. As illustrated in FIG. 2, after “Start” 261 of “Spectral Analysis” 262 is performed on the captured signal. Such spectral analysis is done by an FFT or DFT routines which are commonly known to the proficient in the art. The spectral analysis provides the carrier frequency, modulation type and index of modulation of the captured signal which is stored in memory. Based on the results of the “Spectral Analysis” which renders the captured signal is determined to be AM or FM the flow chart goes to branch as indicated by box 264.

If the spectral analysis establishes that the captured signal is AM, then the next task (266) is the signal is multiplied by a sine wave at the frequency of f+Δf, where f is the carrier frequency of the capture signal determined in the previous steps, i.e., the “Spectral Analysis” and Δf is a small percentage of f, however, several times higher than the data rate. The multiplication procedure is followed by a Lowpass algorithm 267 which serves to remove the high frequency content of the signal which resulted in from the multiplication process. The box following 267 is referred to as 268 which indicates that the data is outputted to a memory device such as EEPROM 200.

When the “Spectral Analysis” establishes that the captured signal is transmitted from an FM source i.e., FSK (Frequency Shift Keying) with two distinct frequencies of f₁ and f₂, one of the two possible different algorithm for determining the code of the reference transmitter is performed. One possible implementation algorithm is multiplying the captured signal by the two different continuous sinusoidal signals corresponding to the two FSK frequencies of f₁ and f₂. The preferred method for FSK signal detection is multiplying the captured signal by sine waves at frequencies near f₁ and f₂, and not exactly f₁ and f₂. As depicted in the flowchart of FIG. 2, when spectral analysis is performed on the captured signal and it is found the captured signal is FM, as denoted by boxes 269 and 273, the signal is multiplied by two sine waves at the frequencies f₁+Δf and f₂+Δf. In an alternative approach the frequencies can be f₁−Δf and f₂−Δf. As mentioned above M is a small percentage of f₁ and f₂. The multiplications by the two sine waves at the frequencies of f₁+Δf (269) and f₂+Δf (273) are done in parallel. The resultant data of these multiplications are followed by identical low pass algorithms referred to outputs 271 and 275 respectively. The low pass filter algorithm is to suppress the high frequency contents which are the resultant of the multiplication processes 269 and 273, i.e., signals at frequencies of 2 f₁+Δf and 2 f₂+Δf. Depending on whether the low pass algorithm 271 or 275 detects presence of signal, a 0 or a 1 is outputted respectively.

The use of frequencies which are in close proximities (with a known frequency difference Δf) is the preferred embodiment of the implementation of FSK signal detection process for to the present invention. If Δf is zero or is very close to zero, at certain phase differences depending on the respective phases of the multiplied signals, the detected signal could be zero or near zero for relatively long period of time. The output contains two sinusoidal signals, which their frequencies are the sum and the difference of the input frequencies and utilizing a low pass algorithm for deriving the envelope which is simply the code of the reference transmitter. As the output is represented by multiplication of two sinusoidal signals which could be expanded in the format:

Sin(2πft)·Sin [2π(f+Δf)t]=½ Cos(2πΔft)−½ Cos [2π(2f+Δf)t] (4)

Where, the second term on the right side of the equation corresponds to the presence of a signal at the frequency of 2f+Δf which is suppressed by the low pass filter function. The first term represents the detected signal contains the low frequency signal Δf.

If Δf is selected to be zero or close to zero, the time needed for detection of symbols is going to be unpredictable. However, when Δf is a known frequency, e.g., 100 kHz, the presence of signal can be detected in a sufficiently short period, i.e., 10 μs.

The frequency, modulation type and the code of the reference transmitter 100 is stored in EEPROM 200 which maintains the data in case of power supply loss.

During the training procedure of the UT according to the present invention, amplifier 120 is enabled by processor 141. The gain of amplifier 120 is initially set at it a moderate level which is subsequently increased or decreased via the commands from processor 141 for obtaining the appropriate amplitude for the signal. The increase and/or decrease in of amplifier 120 continues until the data fed to the ADC 130 is in the proper range so that the number of bits used (at least 8 bits) is sufficient for analysis.

### Transmit Mode

As one of the UT's buttons is pressed, processor 141 is informed via the user interface 240 to retrieve the frequency and the code and modulation type and the modulation index associated with that button from EEPROM 200. Amplifier 120 is disabled during transmit mode. If the reference transmitter is identified as a device with rolling frequencies or codes, then the software routine for generating rolling frequencies and/or codes is called and the appropriate sequence of frequencies and/or codes are generated by the processor 141, otherwise, the fixed code and frequency are regenerated. Processor 141 generates the modulated signal using the information obtained from EEPROM 200.

The computed data from processor 141 are fed to FPGA 142. As a depicted in FIG. 1, each sample is converted to 10 bits and similarly 10 bits are utilized for constructing each slice of the output signal.

Upon the completion of the transfer of the data from processor 141 to FPGA 142, the output of FPGA 142 supplies 8 parallel data streams (10 parallel bits per stream) to multiplexer 145 at the speed of fₛ/8. The multiplexer 145 is clocked at the sampling frequency fₛ and outputs 10 bit slices at the speed of fₛ which are fed to digital to analog converter 150.

The output of digital to analog converter 150 is amplified by the programmable gain amplifier 160. The gain of the amplifier 160 is selected by the processor 141 for the maximum allowable power. Different codes have different duty cycles and according to the rules imposed by regulating agencies (e.g. FCC in the US) the allowable peak power is based on the duty cycle of the code, hence different codes require different peak powers. The criteria for the selection of the gain of programmable gain amplifier 160 is based on the allowable peak transmit power which depends on both the frequency and the code of the transmit signal. The processor 141 determines the allowable peak power and accordingly sets the gain of programmable amplifier 160. The output of amplifier 160 is fed to programmable band pass filter 170.

Programmable band pass filter 170 is comprised of a plurality of band pass filters. Depending on the transmit frequency the appropriate filters are selected by the processor 141. This is done by RF switches connected to programmable antenna matching network 190 which provides the appropriate impedance match to the antenna as different frequency are selected The output of filter 170 is amplified by amplifier 180 followed by programmable antenna matching network 190 which provides the appropriate impedance match to the antenna as different frequency are selected.

Programmable antenna matching network 190 contains a plurality of matching networks. Each matching network provides a near optimum match for certain portion of the band to the antenna. The appropriate matching network selected by RF switches (Transistor or diode switches).

### Universal Transmitter Implementation 2

In this implementation, the frequency of the reference transmitter signal is determined by use of a “gated-counter”. The signal from the reference transmitter is sampled at least at a rate of 3 samples/cycle. Special signal processing circuitry which has an accuracy of a fraction of a cycle determines the presence of sinusoidal bursts. According to this embodiment, the longest practically feasible measurement time for each burst is utilized. Such a scheme minimizes the frequency error, i.e., while the burst is present the gated-counter is enabled for counting the signal transitions (corresponds to zero crossings of sinusoidal RF signal) of the incoming burst. The number of the signal transitions in the burst and the length of the burst are used to calculate the frequency.

The signal from an envelope detector is used for adjustment of the receiver gain to appropriate level and to obtain the bit pattern. The frequency, code, modulation information are stored in a memory device. During the transmit mode, frequency, code, modulation information are retrieved from the memory device. A low distortion frequency stable oscillator such as frequency stabilized dual feedback VCO by use of gated-counter and staircase generator or a DDS generate the carrier. Based on the frequency a band pass network for harmonic reduction and a matching network for the optimum power are selected.

According to this embodiment of the present invention, during the training procedure, first the carrier frequency of the signal is determined by use of a gated frequency counter. Simultaneously, code (AM envelope) detection is carried out by utilizing a sampling envelope detector.

Since sine waves contain portions that are close to zero and pass through zero, merely one sample from signal that falls below threshold level (V_{T}) does not establish the absence of a sinusoidal signal. That is due to the fact that the sample could be taken from the portion of sine wave from the zero crossing point or when is close to a zero crossing.

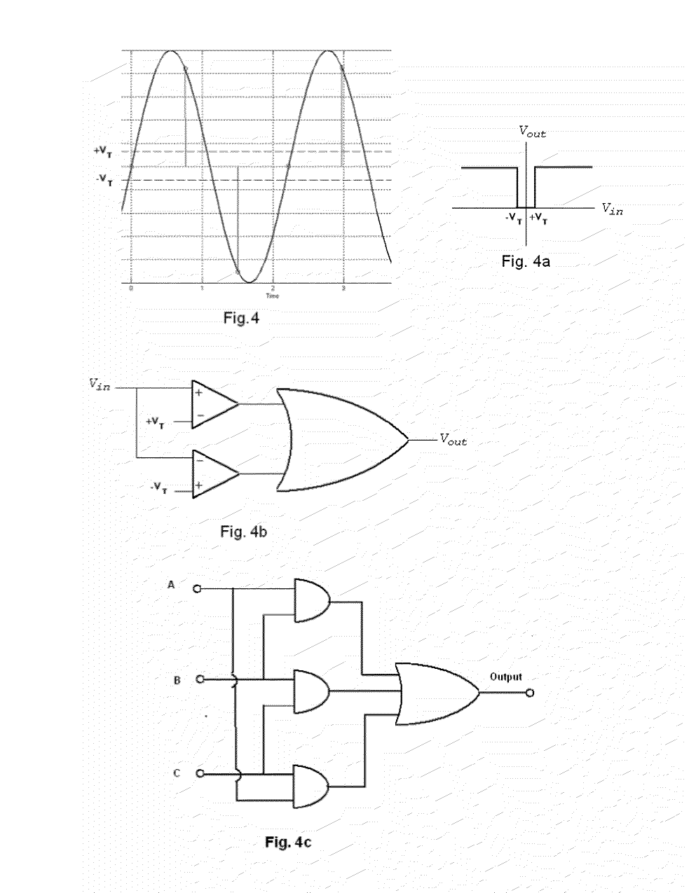

This method can be implemented by a software algorithm or by hardware As the FIG. 4 indicates, when a sine wave is present and three samples per cycle are taken, under any circumstance, at least two of the three samples have magnitudes larger than the threshold voltage V_{T}, i.e., Vₛ∉[−V_{T}, +V_{T}] where Vₛ is the voltage of the signal sample and V_{T} is the threshold voltage which is selected 15% of peak voltages in the example of FIG. 4. Hence, two consecutive zero samples correspond to the absence of signal (logical-0). On the other hand, if the number of samples per cycle is chosen to be very large, e.g., 10, use of 3 consecutive samples as the criteria for assessing the presence of signal is inappropriate, i.e., the 3 close to zero samples could correspond to samples obtained from the “near zero crossing areas” of the signal. Therefore, as mentioned above, first the frequency of the carrier is determined and then the sampling frequency is chosen accordingly, or alternatively, an appropriate criterion for choosing how many below threshold samples are required for deciding a zero signal should be used.

According to this embodiment of the present invention, multiple samples per cycle are used for deciding the presence or absence of a sinusoidal signal. The sampling frequency is kept constant regardless of the frequency of incoming signal. A sampling rate of 1.2 GSPS which corresponds to 3 samples/cycle at the highest frequency (400 MHz) and 6 samples/cycle at the low frequency end (200 MHz). At this rate for the UT frequency band of (200-400 MHz), when V_{T} is selected to be equal or less than 15% of the peak, no two consecutive samples are going to be below threshold when the signal is present. Use of this scheme rather than simple amplitude detection utilizing diode detectors renders a high accuracy for measurement of the length of the burst and consequently renders a more accurate estimate of the frequency of the burst. Additionally when using this technique, the frequency error is minimized since the measurement time is maximized. The maximum error from this scheme is limited to one third of a cycle. As an example for the worst case scenario, frequency of 200 MHz and burst duration of 1 μs, the duration can be underestimated be on third of a cycle, i.e., 1/(200×3)=0.0016 μs yielding an estimate for frequency 200.33 MHz which is sufficiently accurate for UT application. However, frequency measurements from multiple bursts yields even higher accuracy due to error averaging.

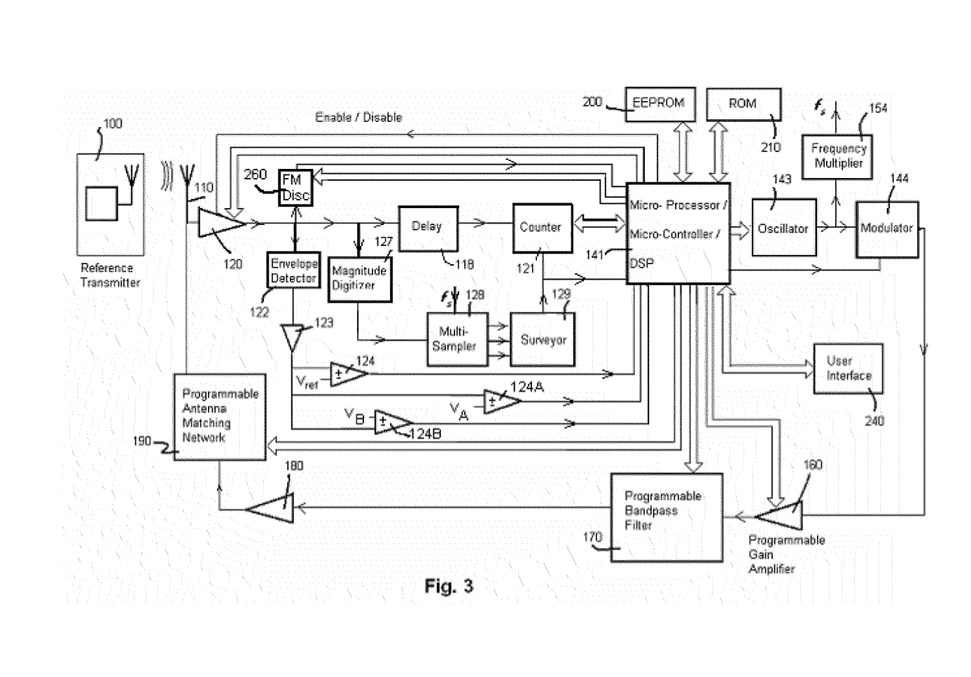

FIG. 3 depicts a possible implementation of the present invention. According to this figure, antenna 110 is followed by programmable gain amplifier 120, followed by a delay line 118 which could be implemented as a transmission line on a circuit board or a coiled miniature coaxial line or alternatively can be implemented with an LC (inductor and capacitor) network. Delay line 118 is followed by gated-counter 121 which its output is connected to processor 141 which could be a microprocessor or a microcontroller or a digital signal processor (DSP) or another FPGA. Processor 141 is connected to two memory devices EEPROM 200 and ROM 210. EEPROM 200 is used for storing information obtained by UT and ROM 210 contains the program which runs the UT. Processor 141 is followed by oscillator 143 which could be a bank of oscillators, a DDS (Direct Digital Synthesis) device, a frequency synthesizer, or a numerical oscillator (e.g. FPGA followed by a multiplexer followed by a high speed digital to analog converter). Use of an ordinary VCO is a less preferred method due to the fact that the VCO's produce compressed sine waves which have excessive harmonic components. Dual feedback VCO (which has inherently low harmonic distortion) in conjunction with a gated-counter for frequency stabilization is a preferred embodiment according to the present invention as depicted in the block diagram of FIG. 12. Oscillator 143 is connected to amplitude modulator 144 followed by the chain of programmable gain amplifier 160, programmable band pass filter 170, amplifier 180 and programmable matching network 190 which is connected to the antenna 110. The output of programmable gain amplifier 120 is followed by FM discriminator 260 which provides a parallel output to processor 141. The detailed block diagram FM discriminator 260 is explained herewith and is depicted in FIG. 6.

The output of oscillator 143 is also connected to by a frequency multiplier 154 which is followed by multi-sampler 128. Frequency multiplier 154 is comprised of an amplifier which drivers a nonlinear element (diode or a transistor at certain bias condition) or a step recovery diode (SRD) which produce various harmonics. By use of appropriate filter circuits, the undesired harmonics and sub-harmonics are filtered and the output signal from the filter is amplified to provide the adequate signal level. A multiplication factor of 5 for frequency multiplier 154 is appropriate. The counting by the gated-frequency counter 121 is performed only during the training procedure when the oscillator 143 is set to a constant frequency (e.g., 300 MHz) which would provide a clock frequency of 1500 MHz to the gated-counter 121 and multi-sampler 128.

There are two other branches from the output of amplifier 120. One branch supplies the signal to a magnitude digitizer 127 feeding a multi-sampler feeding a surveyor circuit 129 which subsequently feeds gated-counter 121. Depending on the magnitude of its input (whether is bellow or above the threshold level V_{T}), magnitude digitizer 127, provides a logical-0 or logical-1. Multi-sampler circuit 128 gathers a few samples, e.g., the three most consecutive outputs from magnitude digitizer 127. The surveyor circuit 129 basically obtains the majority vote amongst the last few (e.g., 3) bits obtained from multi-sampler 127. Magnitude digitizer 128 has the input-output characteristics of absolute value function followed by a level comparator, i.e., for signal magnitudes of greater than certain threshold voltage, i.e., |Vₛ|>V_{T} as its input-output characteristics is depicted in FIG. 4a. A possible implementation of such a circuit would be an absolute value circuit (e.g., bridge rectifier) followed by a comparator circuit. An alternative circuit implementation is depicted in FIG. 4b which is comprised of two comparators and an OR-gate circuit. Multi-sampler circuit 128 is basically a shift register that is clocked by the sampling frequency fₛ. The outputs of multi-sampler circuit 128 are fed in parallel to surveyor circuit 129 which takes the majority vote, i.e., if most of its inputs are logical-1's then it outputs a logical-1, and if most of its inputs are logical-0's then it outputs a logical-0. FIG. 4c shows a possible implementation for a surveyor (voter) circuit 127 using 3 AND-gates and one OR-gate for the case of 3 sample voting case.

The other branch from the output of amplifier 120 is connected to an envelope detector 122 followed by amplifier 123 which feeds the three comparators 124, 124A and 124B. Envelope detector 122, amplifier 123 and comparators 124A and 124B are used for setting the gain of programmable gain amplifier 120 during the training procedures, i.e., the gain of amplifier 120 is adjusted for obtaining a standard signal level at the output of amplifier 120 which feeds the rest of the receiver portion for an optimum signal level as explained bellow.

The user interface 240 contains an LED, a plurality of buttons and authentication hardware as discussed above. Each button can be used for a different gate or garage door or other use. The user interface 240 also includes an LED which is turned on at various events:
(1) To indicate the activation of transmitter as a button is pressed.
(2) Blinking at different rates in order to inform the user about the different stages of training procedure while, e.g., training in progress, training completed, etc. The LED's are located on the interface circuit 240 and are connected and controlled by the processor 141.
(3) Blinking at a very slow rate indicates that an authentication is required.

Alternatively, an LCD could be used to inform the user about the various events and prompts.

In the alternative embodiment wherein voice prompts inform the user about the status of device, the user interface includes a D/A converter and an audio amplifier which in turn feeds a speaker.

According to the present invention in UT which includes user authentication features, one of the following hardware is implemented:
(4) Bio-sensors, e.g., touch pads for sensing fingerprints
(5) Microphones, used for voice recognition
(6) Keypads, i.e., several buttons for entry of a pass code for, e.g. 6 buttons which could also function for other purposes.

### Training Mode

During training mode the UT learns the frequency and the code of a reference transmitter. The reference transmitter is brought close to the UT and the transmit button on the reference transmitter and one of UT buttons (located on user interface 240) are pressed simultaneously. If already there is a code and a frequency saved in the memory associated button previously, after certain period of time, e.g., 10 seconds the processor stops transmitting. However, when the memory associated with that button is blank, the training procedure starts immediately. The training procedure is as follows.

Antenna 110 receives the signal from the reference transmitter 100. The received signal is amplified by programmable gain amplifier 120. The gain of amplifier 120 is pre-set at a moderate gain value.

The output of amplifier 120 is demodulated by envelope detector 122 and amplified by amplifier 123 and compared against the three voltages V_{ref}, V_{A} and V_{B} by comparators 124, 124A and 124B. The V_{ref} is a reference supplied to the inverting input of comparator 124 which is used to be compared against the amplified detected voltages available at the output of 123. The output of comparator 124 is the detected data and is supplied as an input to processor 141. A reference voltage V_{A} is connected to the inverting input of comparator 124A and the output of amplifier 123 is connected to the non-inverting input of comparator 124A. A reference voltage V_{B} is connected to the non-inverting input of comparator 124A and the output of amplifier 123 is connected to the inverting input of comparator 124A.

The voltages V_{A} and V_{B} and gains of amplifier 123, are selected for the criteria that when the gain of amplifier 120 is adjusted to the appropriate range, the output voltage of amplifier 123 would fall in the range of [V_{A}, V_{B}], i.e., logic-1 at both outputs of two comparators 124A and 124B. As a result, when two comparators 124A and 124B are outputting logical-1 to processor 141, that means that the next step in training process is followed.

When the output of 123 is less than V_{A}, the output of comparator 124A is low, and the gain of amplifier 120 is increased in small steps until the output of comparator 124A switches to high which corresponds to sufficient signal level for the output of 123. However, when the output of 123 is more than V_{B}, which results in a logical-0 at the output of comparator 124B corresponding to high signal level for the output of 120, the gain of amplifier 120 is decreased in small steps until the output of comparator 124B is switched to logical-1 which corresponds to selection appropriate gain for amplifier 120 resulting in the proper signal level at the output of 120.

When the gain of amplifier 120 is adjusted in the proper range, the signal level is at an appropriate level for envelope detector 122 and magnitude digitizer 127 which are used for determining the frequency and the code of incoming signal. The detected code which is available at the output of comparator 124 is supplied to processor 141 and the bit pattern is identified by processor 141 and is subsequently stored in EEPROM 200.

The amplified signal level at its output is suitable for feeding magnitude digitizer 127. The output of magnitude digitizer 127 is fed to multi-sampler 128 which stores last three outputs from magnitude digitizer 127. The surveyor circuit 129 takes a vote for determining whether a sinusoidal signal is present or not. When the presence of signal is detected by surveyor 129, gated-counter 121 waits for a sufficiently long period of time in order to overcome the delay caused by the delay circuit 118 as well to assure that there is sufficient delay before the gated-counter is enabled and the transients produced as a result of transition of signal from low to high are decayed. This can possibly be done by a timer circuit or alternatively can be done in the software by counting enough number of clock cycles operating at the frequency of fₛ or other available clocks in the system. Subsequently, the gated-counter circuit 121 starts to count the number of transitions of the signal which is supplied by delay circuit 118 and the counting ends when the surveyor circuit 129 reports the absence of signal. As a result, the frequency of the burst can be precisely measured by dividing the number of transitions of the signal by the period of the burst.

The carrier frequency and the bit pattern and the associated button on the user interface 240 are stored in EEPROM 200 for future reference.

### Transmit Mode

As one of the UT's buttons is pressed, processor 141 is informed via the user interface 240 to retrieve the frequency and the code and modulation type and index associated with that button from EEPROM 200. Amplifier 120 is disabled during transmit mode If the reference transmitter is identified as a device with rolling frequencies or codes, then the software routine for generating rolling frequencies and/or codes is called and the appropriate sequence of frequencies and/or codes are generated by the processor 141. Otherwise, the fixed code and frequency are regenerated. Processor 141 numerically generates the modulated signal using the information obtained from EEPROM 200.

The output of modulator 144 is amplified by programmable gain amplifier 160. The gain of the amplifier 160 is selected by the processor 141 for the maximum allowable power. Since different codes have different duty cycles the allowable peak power is determined by the duty cycle of the code. The gain of amplifier 160 is based on the allowable peak transmit power which is calculated by processor 141 based on the rules enforced by the regulating agencies which depends on both the frequency and the code of the transmit signal. Then the processor 141 determines the peak power and accordingly sets the gain of programmable gain amplifier 160. The output of amplifier 160 is fed to programmable band pass filter 170.

Programmable band pass filter 170 is comprised of a plurality of band pass filters. Depending on the transmit frequency the appropriate filters are selected by the processor 141. This is done by RF switches connected to programmable antenna matching network 190 which provides the appropriate impedance match to the antenna as different frequency are selected The output of filter 170 is amplified by amplifier 180 followed by programmable antenna matching network 190 which provides the appropriate impedance match to the antenna as different frequency are selected.

Programmable antenna matching network 190 contains a plurality of matching networks. Each matching network provides a near optimum match for certain portion of the band to the antenna. The appropriate matching network selected by RF switches (Transistor or diode switches).

### Universal Transmitter Implementation 3

According to this preferred embodiment, time domain technique is utilized for frequency measurements. This done by utilizing a built-in gated-counter circuit which counts the transitions low-to-high, high-to-low or both from the portion of the signal from the reference transmitter. This is used for measuring and the carrier frequency of the reference transmitter which is determined by dividing the number of transitions by the time period of measurement. Certain counter circuits count both types of transitions, i.e., low-to-high and high-to-low in which case the carrier frequency determined by dividing the total counted transitions by twice the time period of counting.

The gated-counter circuit is required to handle the speed (450 MHz) and resolution (sufficient number of bits) e.g., 10 bits with reset-able to zero and enable/disable functions is appropriate for the application. A possible implementation for such a counter using J-K flip-flops and AND-gates is depicted in FIG. 10. Other possible techniques for implementation of the gated-counter with similar function include use of different hardware, e.g., FPGA's, or different types of flip flops.

In order to achieve high measurement accuracy, the counter is enabled after a nominal period of time so that the transients are decayed. As described below, the circuitry implemented in such a way that both the counting process and the window of time window which is designated for counting end before the burst ends under any possible circumstances.

FIG. 5 depicts a possible implementation of the UT according to the present invention. Initially, counter is reset to all zeros, when envelope detector 122 detects the presence of signal, after a nominal time delay imposed by timer circuit 125, the gated-counter 126 is enabled. The frequency measurement is performed while the UT is receiving only a portion of a logical-1 signal (e.g., waiting for 0.2 μs after receiving of a signal and then the measurement is performed in the next 1 μs). Delay is introduced by timer circuit 125 in order to assure that there is sufficient delay before the gated-counter is enabled and the transients produced as a result of transition of signal from low to high are substantially decayed.

According to FIG. 5, antenna 110 is connected to the RF input of programmable gain amplifier 120, followed by a delay line 118 which could be implemented as a transmission line on a circuit board or a coiled miniature coaxial line or alternatively can be implemented with an LC (Inductor+capacitor) network. Delay line 118 is followed by gated-counter 126 which outputs to processor 141 which a microprocessor or a microcontroller or a digital signal processor (DSP) or another FPGA are possible devices to be used. Processor 141 is connected to two memory devices EEPROM 200 and ROM 210. EEPROM 200 is used for storing information obtained by UT and ROM 210 contains the program which runs the UT. Processor 141 is followed by oscillator 143 which could be comprised of a bank of oscillators, DDS (direct digital synthesis) device, VCO based frequency synthesizer, or a numerical oscillator (e.g., FPGA followed by a multiplexer followed by a high speed digital to analog converter). Use of an ordinary VCO in the synthesizer is the less preferred choice due to the fact that the VCO's produce compressed sine waves suffering from excessive harmonic components.

The output of programmable gain amplifier 120 is followed by FM discriminator 260 which provides a parallel output to processor 141. The detailed block diagram of FM discriminator 260 is explained earlier and is depicted in FIG. 6.

The output of oscillator 143 is connected to the input of amplitude modulator 404 which in turn is followed by programmable gain amplifier 160 which its output is connected to the input of programmable band pass filter 170 and it is followed by an RF amplifier 180. Programmable matching network 190 connected between antenna 110 and RF amplifier 180. Parallel buses are connected from processor 141 to programmable gain amplifier 120, gated-counter 126, EEPROM 200, ROM 210, FM discriminator 260, oscillator 143, programmable gain amplifier 160, programmable band pass filter 170, and programmable matching network 190.

The other branch from the output of amplifier 120 is connected to an envelope detector 122 followed by amplifier 123 which feeds comparators 124, 124A and 124B. This branch of devices serves three different purposes:

(1) Detect the received signal level during the training process in order to increase/decrease the selected gain of amplifier 120 so that the signal processed by the UT is at the appropriate level.

(2) Detect the code of that is modulating the reference transmitter which is provided by comparator 124.

(3) Detect the presence of carrier while the gated-counter 126 is counting the carrier frequency and the timer 125 keeps track of the time of while counting is in progress. The output of comparator 124 is also provided to timer circuit 125. Timer 125 provides a small delay (e.g., 0.2 μs) after detection of carrier for enabling gated-counter 126. Subsequently, timer circuit 125 waits for a nominal time (e.g., 1 μs) while gated-frequency counter 126 counts the transitions (with either positive or negative transitions). At the end of the nominal time, timer circuit 125 disables gated-frequency counter 126. The output of the gated-counter 126 is fed into the processor 141.

The user interface 240 contains an LED, a plurality of buttons and authentication hardware as discussed above. Each button can be used for a different gate or garage door or other use. The user interface 240 also includes an LED which is turned on at various events:
(1) To indicate the activation of transmitter as a button is pressed.
(2) Blinking at different rates in order to inform the user about the different stages of training procedure while, e.g., training in progress, training completed, etc. The LED's are located on the interface circuit 240 and are connected and controlled by the processor 141.
(3) Blinking at a very slow rate indicates that an authentication is required.

Alternatively, an LCD could be used to inform the user about the various events and prompts.

In the alternative embodiment wherein voice prompts inform the user about the status of device, the user interface includes a D/A converter and an audio amplifier which in turn feeds a speaker.

According to the present invention in UT which includes user authentication features, one of the following hardware is implemented:
(7) Bio-sensors, e.g., touch pads for sensing fingerprints
(8) Microphones, used for voice recognition
(9) Keypads, i.e., several buttons for entry of a pass code for, e.g. 6 buttons which could also function for other purposes.

### Training Mode

During training mode the UT learns the frequency and the code of a reference transmitter. The reference transmitter is brought close to the UT and the transmit button on the reference transmitter and one of UT buttons (located on user interface 240) are pressed simultaneously. If already there is a code and a frequency saved in the memory associated button previously, after certain period of time, e.g., 10 seconds the processor stops transmitting. However, when the memory associated with that button is blank, the training procedure starts immediately. The training procedure is as follows.

Antenna 110 receives the signal from the reference transmitter 100. The received signal is amplified by programmable gain amplifier 120. The gain of amplifier 120 is pre-set at a moderate gain value.

The output of amplifier 120 is demodulated by envelope detector 122 and amplified by amplifier 123 and compared against the three voltages V_{ref}, V_{A} and V_{B} by comparators 124, 124A and 124B. The V_{ref} is a reference supplied to the inverting input of comparator 124 which is used to be compared against the amplified detected voltages available at the output of 123. The output of comparator 124 is the detected data and is supplied as an input to processor 141. A reference voltage V_{A} is connected to the inverting input of comparator 124A and the output of amplifier 123 is connected to the non-inverting input of comparator 124A. A reference voltage V_{B} is connected to the non-inverting input of comparator 124A and the output of amplifier 123 is connected to the inverting input of comparator 124A.

The voltages V_{A} and V_{B} and gains of amplifier 123, are selected for the criteria that when the gain of amplifier 120 is adjusted to the appropriate range, the output voltage of amplifier 123 would fall in the range of [V_{A}, V_{B}] which results in high logic at both outputs of two comparators 124A and 1246. As a result, when two comparators 124A and 1246 are outputting high logic to processor 141, the next step in training process is followed.

When the output of 123 is less than V_{A}, the output of comparator 124A is low, and the gain of amplifier 120 is increased in small steps until the output of comparator 124A switches to high which corresponds to sufficient signal level for the output of 123. However, when the output of 123 is more than V_{B}, which results in a logical-0 at the output of comparator 1248 corresponding to high signal level for the output of 120, the gain of amplifier 120 is decreased in small steps until the output of comparator 124B is switched to logical-1 which corresponds to selection appropriate gain for amplifier 120 resulting in the proper signal level at the output of 120.

When the gain of amplifier 120 is adjusted in the proper range, the signal level is at an appropriate level for envelope detector 122, as the amplified received signal feeds detector 122 and gets amplified by amplifier 123 and is compared against a reference voltage V_{ref} by comparator 124. When a signal is detected, the output of comparator 124 goes to logical-1 which in turn enables gated-counter 126 and sets timer 125 to provide a pulse for a nominal period of time, e.g., 1 μs. Gated-counter 126 starts to count the number of transitions during the nominal period. At the completion of the counting period the number of transitions is outputted to processor 141. The carrier frequency is determined by the processor 141 by dividing the number of transitions (from high to low or vice versa or both) by the period of counting which is provided by the gated-counter.

Two different criteria for the selection of the duration of counting time (the time that the gated-counter 126 is turned on can be used. The counter can be set to be on by timer 125 on for a short period of time which is known to be shorter than the duration of any burst which is produced by the garage door openers available in the market (e.g., 1 μs).

Alternatively, by use of different methodology, the time for frequency measurement is maximized which renders higher measurement accuracy. According to this technique which is the preferred embodiment of the present invention for frequency measurement, shortly before the end of a burst, gated-counter 126 stops the counting and the timer 125 stops the time measurement. As depicted in FIG. 5, this is realized by utilizing delay line 118 which provides the delayed version of the burst to gated-counter 126. The non-delayed version of the burst is fed to envelope detector 122 and amplifier 123 and comparator 124 producing the non-delayed bit pattern of the reference transmitter. The non-delayed bit pattern is fed to:

(1) Processor 141 as the code for the reference transmitter and subsequently stored in EEPROM 200 for future reference.

(2) Timer 125 in which the trailing edges of the bit pattern is used as the trigger to stop the time measurement.

(3) Gated-counter 126 in which the trailing edges of the bit pattern are used as the trigger to stop counting. The carrier frequency is calculated by dividing the number of transitions to the duration of measurement. The second method provides a more accurate frequency measurement since it utilizes a longer period of time for frequency measurements since truncation errors are play a smaller role.

The output of comparator circuit 124 is fed to processor 141 which collects the sequence of detected 0's and 1's until the repetition of a pattern is detected and the bit pattern is identified by processor 141. The carrier frequency and the bit pattern and the associated button on the user interface 240 are stored in EEPROM 200 for future reference.

### Transmit Mode

As one of the UT's buttons is pressed, processor 141 is informed via the user interface 240 to retrieve the frequency and the code and modulation type and index associated with that button from EEPROM 200. Amplifier 120 is disabled during transmit mode If the reference transmitter is identified as a device with rolling frequencies or codes, then the software routine for generating rolling frequencies and/or codes is called and the appropriate sequence of frequencies and/or codes are generated by the processor 141. Otherwise, the fixed code and frequency are regenerated. Processor 141 numerically generates the modulated signal using the information obtained from EEPROM 200.

The output of modulator 144 is amplified by programmable gain amplifier 160. The gain of the amplifier 160 is selected by the processor 141 for the maximum allowable power. Since different codes have different duty cycles the allowable peak power is determined by the duty cycle of the code. The gain of amplifier 160 is based on the allowable peak transmit power which is calculated by processor 141 based on the rules enforced by the regulating agencies which depends on both the frequency and the code of the transmit signal. Then the processor 141 determines the peak power and accordingly sets the gain of programmable gain amplifier 160. The output of amplifier 160 is fed to programmable band pass filter 170.

Programmable band pass filter 170 is comprised of a plurality of band pass filters and RF switches. Depending on the transmit frequency the appropriate filter is selected by the processor 141.

Programmable antenna matching network 190 contains a plurality of matching networks. Each matching network provides a near optimum match for certain portion of the band to the antenna. The appropriate matching network selected by RF switches (Transistor or diode switches).

### Realization of Multifunctional Units

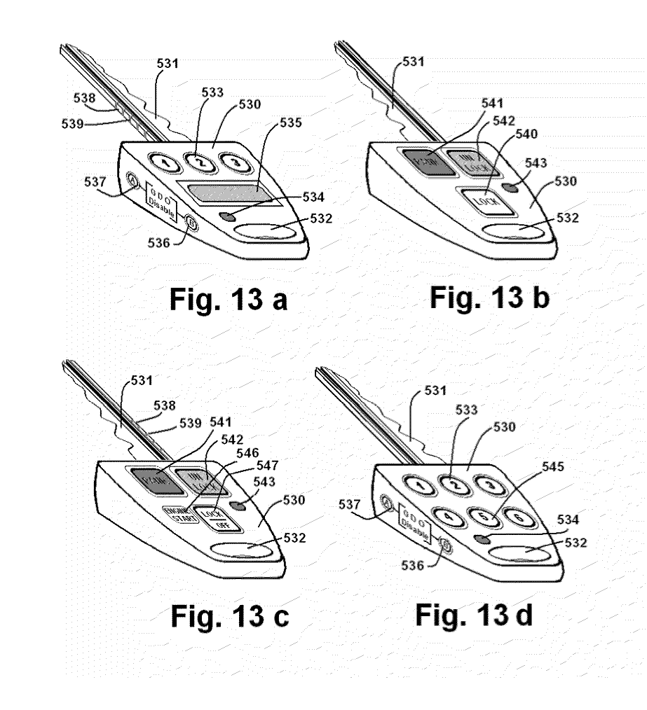

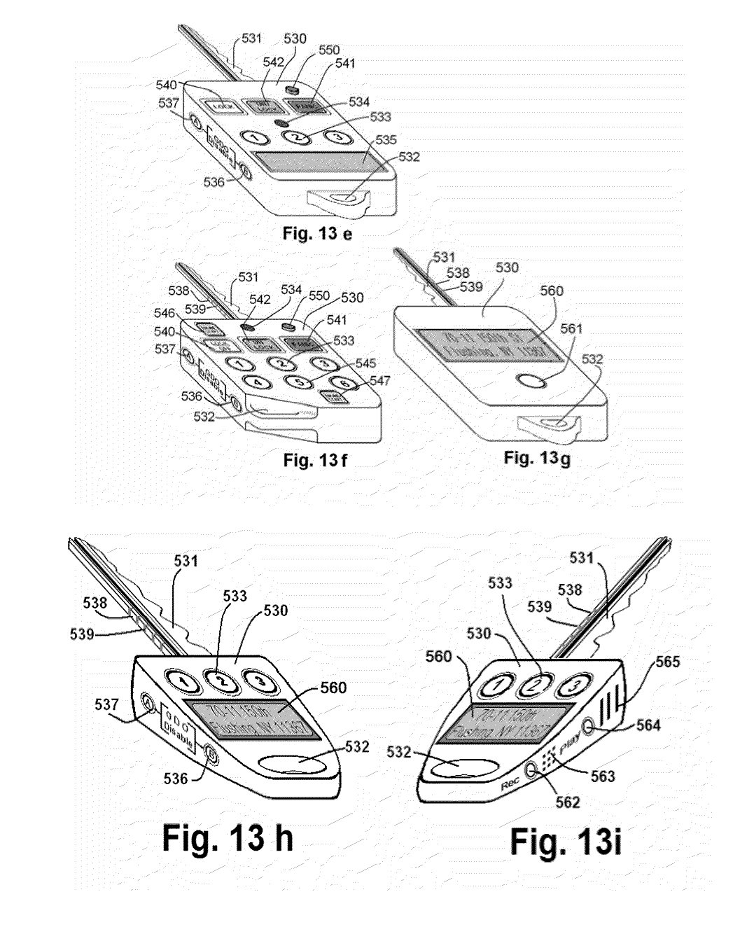

FIGS. 13a, 13b, 13c, 13d, 13e, 13f, 13g, 13h and 13i depict possible fascias for keys with fobs attached (preferably for an ignition key). These figures exemplify partial/complete realizations of remote controlled transmitters and/or RLV's according to the present invention. According to these figures, key fobs include key blade 531 and fob 530. As depicted, in each figure, opening 532 is implemented in fob 530 for passing a key chain/ring. As a preferred embodiment of the present invention, in some of the realizations as depicted in the figures, key blade 531 includes a plurality of electrical contacts, e.g., contact 538. These contacts are implemented to provide electrical contact to other circuitry/systems in the vehicle while the key is in the key slot. Some examples of communications between the circuitry in the vehicle are RF signal to a transmission line to connect to an antenna installed on the vehicle (e.g., windshield), data from GPS, authentication data stored in the key for theft protection, and also for recharging the battery inside the fob. The authentication information in the fob can be fixed or for high security can be variable codes or rolling codes. In a realization with electrical contacts, key blade 531 includes a plurality of insulators, e.g., insulator 539 as shown in the figures for providing electrical insulation and mechanical support for the contacts. A preferred selection for material for the insulators is composite material with high tensile strength. An appropriate choice for the location of an external antenna for such operation is the windshield of the vehicle in such case there is a good direct signal path to the garage door opener receiver. Alternatively, the antenna can be implemented on the top surface of dashboard (cover under the dashboard plastic layer) which also can provide a good signal path to the garage door opener receiver which is located distantly.

Some appropriate choice for type of antenna regardless of whether is internal (in the fob) or external (e.g., on the windshield) are depicted in FIG. 9j with its inter-digital resonating capacitors are as implemented in FIG. 9k. A windshield antenna for the frequency of interest can be designed to have very small size, e.g., 1″×1″. The selection of material for the antenna can be of semi-transparent conducting material so it would be esthetically suitable.

According to a preferred embodiment of the present invention, any combination of up to three devices can be combined on a key fob (preferably an ignition key), e.g., two sides of key fob 530 are utilized in order to have various functions of remote keyless entry as well as garage door opener, i.e., Universal Transmitter (UT) and also an RLV (Recent Location of Vehicle) unit. Depending on the model, and manufacturer's/user's preference any combination of these three functions can be implemented on a key fob.

In FIG. 13a, there are three buttons which are located in a single row and are utilized for garage door opener function. The middle button 533 is labeled “2”. LED 534 is used for indicating the status of the device to the user at various circumstances. According to this implementation, buttons 536 (labeled as “B” button) and 537 (labeled as “A” button) are located on the narrow side of the fob and are used to disable the remote control functions, i.e., the garage door opening function or keyless remote entry function for security purpose, e.g., in an instance that the owner has concerns that during the time when the vehicle is left with a parking attendant, he/she could copy the garage door opening code unto another device. In order to avoid any accidental set-offs, only when both buttons 536 and 537 are pressed simultaneously the garage door opening function is disabled. To aid the operator, the legend “GDO Disable” is printed and/or engraved on the side pointing to both buttons 536 and 537. In a variation to this embodiment, the user can disable the remote control functions by entering a code using the buttons on the fob or alternatively using the buttons on the fob followed by pressing the buttons 536 and 537.

When the garage door opening function is disabled and a button for garage door opening is pressed, the user is informed by voice prompt and/or LED 534 blinks with a special pattern (e.g., two short blinks followed by a long blink) to indicate that the garage door opener is not producing the garage door opening transmit signal. Subsequently, by touching of pad 535, the user is authenticated and the garage door function is enabled the user is also informed by voice prompt and/or LED 534 blinks with a special pattern (e.g., a long blink). Sensing pad 535 is the top portion of a biosensor mechanism which uses fingerprints to authenticate the user. The rest of biosensor mechanism is situated inside the fob.

FIG. 13b depicts a possible implementation for a typical ignition key which is attached to a fob. As depicted in FIG. 13b, three buttons for keyless remote entry function are used. Button 540 is marked as “LOCK” which is used for remotely locking the doors of the vehicle. Button 542 is marked as “UNLOCK” which is used for remotely unlocking the doors of the vehicle. Button 541 is marked as “PANIC” which is used for remotely locating the vehicle or other circumstances such as emergencies. By pressing this button a mechanism in the vehicle is activated which causes a honking and/or flashing some of the lights of the vehicle such as blinker lights or headlights and taillights. Light emitting diode (LED) 543 is used to indicate that a button is pressed.

FIG. 13c is depiction of an ignition or other type of key with attached to fob 530 similar to the depiction of FIG. 13b. Button 546 is added to this implementation and is marked as “START”. It is used to start the engine remotely. The engine is shut off when the key 547 marked as “LOCK/OFF” is pressed.

FIG. 13d is another depiction for an ignition or other type of key attached to fob 530 according to the present invention. According to this implementation, there are two rows of three, i.e., six buttons. Similar to FIG. 13a, the middle button 533 is marked in the top row as “2”. Button 545 marked as “5” is in the second row of buttons which are substituting the biosensor 535 of FIG. 13a. Both rows of buttons, i.e. the six buttons are used for user authentication as well as additional garage door opener function and/or remote keyless entry (RKE) and/or other applications such as lights, door lock of the house. According to this embodiment a security code is used for authentication. A 4-digit code provides 6⁴=1296 different combinations. LED 534 is used for indicating the status of the device to the user at various circumstances. According to this implementation, buttons 536 (labeled as “B” button) and 537 (labeled as “A” button) are located on the narrow side of the fob and are used to disable the remote control functions, i.e., the garage door opening function or keyless remote entry function for security purpose, e.g., in an instance that the owner has concerns that during the time when the vehicle is left with a parking attendant, he/she could copy the garage door opening code unto another device. In order to avoid any accidental set-offs, only when both buttons 536 and 537 are pressed simultaneously the garage door opening function is disabled. To aid the operator, the legend “GDO Disable” is printed and/or engraved on the side pointing to both buttons 536 and 537. In another embodiment, the user can disable the remote control functions by entering a code using both, i.e., the buttons on the fob or alternatively using the buttons on the fob followed by pressing the buttons 536 and 537.

According to a preferred embodiment of the present invention, FIG. 13b or 13c represent the opposite side of the key fob of FIG. 13a or 13d which provides convenience to the user by combining two functions on the same unit.

When the garage door opening function is disabled and a button for garage door opening is pressed, LED 534 blinks with a special pattern (e.g., two short blinks followed by a long blink) to indicate that the garage door opener is not producing the garage door opening transmit signal. Subsequently, by entering the security code the user is authenticated and the garage door function is enabled.

FIG. 13e depicts another type of a key fob, wherein the buttons on FIGS. 13a and 13b are implemented on only one side of the fob. In addition, button 500 is added for release of the spring loaded key blade 531. Opening 532 is implemented in fob 530 for use with a key chain/ring. In FIG. 13e similar to FIG. 13a, the three buttons located in a single row for garage door opener function are utilized and the middle button 533 is marked as “2”. LED 534 is used to indicate the status of the device to the user at the various circumstances. Button 540 is marked as “LOCK” which is used for remotely locking the doors of the vehicle. Button 542 is marked as “UNLOCK” which is used for remotely unlocking the doors of the vehicle. Button 541 is marked as “PANIC” which is used for remotely locating the vehicle or other uses in emergency circumstances. By pressing this button a mechanism in the vehicle is activated which causes a honking and/or flashing some of the lights of the vehicle such as blinker lights or head lights and tail lights. LED 534 is used for indicating the status of the device to the user at various circumstances. According to this implementation, buttons 536 (labeled as “B” button) and 537 (labeled as “A” button) are located on the narrow side of the fob and are used to disable the garage door opening function for security purpose, e.g., in an instance that the owner has concerns that during the time when the vehicle is left with a parking attendant, he/she could copy the garage door opening code unto another device. In order to avoid any accidental set-offs, only when both buttons 536 and 537 are pressed simultaneously the garage door opening function is disabled. To aid the operator, the legend “GDO Disable” is printed and/or engraved on the side pointing to both buttons 536 and 537. When the garage door opening function is disabled and a button for garage door opening is pressed, LED 534 blinks with a special pattern (e.g., two short blinks followed by a long blink) to indicate that the garage door opener is not producing the garage door opening transmit signal. Sensing pad 535 is a portion of a biosensor mechanism which uses fingerprints to authenticate the user. The rest of biosensor mechanism is situated inside the fob. When the garage door opener function is disabled, and the user presses one of the three buttons designated for that purpose, user is informed by special blinking of LED 534. Subsequently, by touching of pad 535, the user is authenticated and the garage door function is enabled.

FIG. 13f depicts a key fob wherein the buttons on FIGS. 13c and 13b are implemented on the on side of the fob. In addition, button 500 is added for release of the spring loaded key blade 531. Opening 532 is implemented in fob 530 for use with a key chain/ring. The other addition is a secondary “ENGINE START” button 547. Both buttons 546 and 547 must be pressed simultaneously in order to prevent an accidental activation of the “ENGINE START”. According to this implementation, there are two rows of three, i.e., six buttons. Similar to FIG. 13e, the middle button 533 in the top row is marked “2”. Button 545 on the second row is marked “5” is in the second row of buttons which are substituting the biosensor 535 of FIG. 13a. Both rows of buttons, i.e., the six buttons are used for user authentication as well as additional garage door opener function and/or remote keyless entry (RKE). According to this embodiment a security code is used for authentication. A 4-digit code provides 6⁴=1296 different combinations. LED 534 is used to indicate the status of the device to the user at the various circumstances. Button 540 is marked as “LOCK” which is used for remotely locking the doors of the vehicle. Button 542 is marked as “UNLOCK” which is used for remotely unlocking the doors of the vehicle. Button 541 is marked as “PANIC” which is used for remotely locating the vehicle or other uses in emergency circumstances. By pressing this button a mechanism in the vehicle is activated which causes a honking and/or flashing some of the lights of the vehicle such as blinker lights or head lights and tail lights. LED 534 is used for indicating the status of the device to the user at various circumstances.

According to this implementation, buttons 536 (labeled as “B” button) and 537 (labeled as “A” button) are located on the narrow side of the fob and are used to disable the remote control functions, i.e., the garage door opening function or keyless remote entry function for security purpose, e.g., in an instance that the owner has concerns that during the time when the vehicle is left with a parking attendant, he/she could copy the garage door opening code unto another device.

In order to avoid any accidental set-offs, only when both buttons 536 and 537 are pressed simultaneously the garage door opening function is disabled. To aid the operator, the legend “GDO Disable” is printed and/or engraved on the side pointing to both buttons 536 and 537. In a variation to this embodiment, the user can disable the remote control functions by entering a code using the buttons on the fob or alternatively using the buttons on the fob followed by pressing the buttons 536 and 537.

When the garage door opening function is disabled and a button for garage door opening is pressed, LED 534 blinks with a special pattern (e.g., two short blinks followed by a long blink) to indicate that the garage door opener is not producing the garage door opening transmit signal. When the garage door opener function is disabled, and the user presses one of the three buttons designated for that purpose, user is informed by special blinking of LED 534. Subsequently, by entering the security code the user is authenticated and the garage door function is enabled.

FIG. 13g depicts an implementation of an RLV (Recent Location of Vehicle) unit on a key fob. This depiction can be a representative drawing for a stand alone unit or alternatively it can be a depiction for a combination unit in which on the opposite side buttons for UGDO/RKE system are implemented similar to depictions in FIGS. 13e and 13f. According to this preferred embodiment of the present invention, the address of the location that the vehicle was parked last is stored in a memory device in the key fob. The location information is supplied to the RLV unit implemented in the fob by a GPS receiver or a navigation system which is available in the vehicle. The location information is transferred to the RLV unit either by wireless means or through the contacts of the ignition key.

According to a preferred embodiment of the present invention the data transfer for the location information launches immediately after the ignition is turned off. One possible implementation for such a system could be based on initiating the data transfer to the fob immediately after the ignition is turned off. A short beep can be used to indicate to the user that the data transfer was successful and repeated long beeps can be used to indicate to the user an unsuccessful data transfer or improper address. The beeping mechanism could be either in the fob or implemented in the vehicle. By utilizing a delay circuit which keeps the power supply of the GPS for a short period of time (e.g., 100 ms) after the ignition is turned off there is sufficient time for such a data transfer. In an alternative scheme when the passenger detection system detects passenger has left the vehicle can wirelessly transfer the data related to the key fob.

In another preferred embodiment according to the present invention a voice recording and playing device in the RLV unit is the incorporated. The hardware that is used for voice recording and playing is composed of a microphone for converting voice sound into electrical signals, an audio amplifier with automatic gain control to amplify the electrical signals to the proper level, an analog to digital converter (ADC) to digitize the voice, a microcontroller for controlling handling users interface and data collection and retrieval, a memory device for storing recorded messages and prerecorded voice prompts, a digital to analog converter (DAC) to convert the digital data into audio analog signals, another audio amplifier for amplifying the recorded audio signal to the proper level, and a miniature speaker for converting the electrical audio signals into acoustical signals. This embodiment is used for certain situations that the RLV unit does not receive any data either due to the absence of GPS signals, or the received data is not suitable for use due to the fact that the location where the vehicle is parked does not have an address or the location of parked vehicle is not well defined, e.g., in a deep underground garage, in a spot of a parking lot of a stadium or a road with no buildings present and therefore there is no recognizable address. According to this embodiment in a situation that the RLV unit does not have an appropriate address for the location where the vehicle is parked, a synthesized voice prompts the operator, e.g.: “PLEASE RECORD A DESCRIPTION FOR THE LOCATION OF VEHICLE”. In response to the prompt, the operator of the vehicle utters the description of the location, e.g.: “LEVEL 3, PARKING SPOT NUMBER 26”. The location information which is uttered by the operator is recorded via said microphone audio amplifier, DAC and saved in a memory device available in the RLV unit. In the circumstance that the operator of the vehicle forgets the location where he/she has parked the vehicle, by pressing a button 561 twice, the recorded voice is played. Upon pressing the play button by the operator, the recorded data is converted into analog and amplified by the second audio amplifier and converted into sound by the miniature speaker available in the RLV unit.

FIG. 13g is a representative for two different embodiments of the present invention. According to one embodiment FIG. 13g represents one side of a key fob and the opposite side of the key fobs incorporates universal garage door opener (UGDO) function or a remote keyless entry (RKE) or the combination of both similar to functions as portrayed in FIGS. 13a, 13b, 13c, 13d, 13e and 13f. Alternatively, according to the other embodiment FIG. 13g represents an independent key fob which corresponds to a standalone RLV unit.

FIG. 13h depicts an implementation for an RLV unit on a key fob. The buttons on FIGS. 13h and 13i are similar to those on FIG. 13a. However, the LED and the biosensor touching pad is replaced with an LCD. As depicted in both FIGS. 13h and 13i, there are three buttons which are located in a single row and are utilized for garage door opener function. The middle button 533 is marked “2”.

According to this implementation, buttons 536 (labeled as “B” button) and 537 (labeled as “A” button) which are located on the narrow side of the fob are used to disable the remote control functions, i.e., the garage door opening function or keyless remote entry function for security purpose, e.g., in an instance that the owner has concerns that during the time when the vehicle is left with a parking attendant, he/she could copy the garage door opening code unto another device. In order to avoid any accidental set-offs, only when both buttons 536 and 537 are pressed simultaneously the garage door opening function is disabled. To aid the operator, the legend “GDO Disable” is printed and/or engraved on the side pointing to both buttons 536 and 537. In a variation to this embodiment, the user can disable the remote control functions by entering a code using the buttons on the fob or alternatively using the buttons on the fob followed by pressing the buttons 536 and 537.

When the garage door opening function is disabled and a key for garage door opening is pressed, LCD 534 indicates a message, e.g.: “PLEASE ENTER CODE”. The code can be a 5 character code wherein 536 (button B) and 537 (button A) as well as “1”, “2” and “3” buttons are possibly used for a pass code. A 5-digit code provides 5⁵=3125 different combinations. If any combinations of the buttons are pressed which are incorrect or insufficient after delay of a nominal time, e.g., 30 seconds the entry is discarded and the user is informed by a message, e.g., “INVALID ENTRY” followed by the message: “PLEASE ENTER CODE”.

FIG. 13i is a depiction of the key fob of FIG. 13h from a different perspective angle wherein the functions of voice recording and voice playing are added to the key fob of FIG. 13h. According to this preferred embodiment of the present invention a voice recording and playing device in the RLV unit is incorporated. As depicted, matrix holes 563 are located on the side of key fob 530 for providing air path ways to the microphone which is inside the key fob for recording and a plurality of slot holes are which are labeled as 565 are for providing air path ways for said miniature speaker as its function was described above. Button 562 is pressed by the user while he/she is recording a message and it is marked with the legend “Rec” (abbreviation for Record). Similarly, button 564 is pressed by the user when the recorded message is being played and marked with the legend “Play”.

According to another preferred embodiment of the present invention the flow of data from the GPS to the RLV unit is continuous and as the vehicle travels to a new a location the data for that most recent address is transferred to the RLV unit. Consequently, when the vehicle reaches its destination the address of the last location where the vehicle was stopped at is kept in the RLV unit. In a preferred embodiment according to the present invention, the location information, i.e., the addresses are continuously displayed on the LCD located on the fob, and upon activation by the operator, by pressing a button the address can be provided by auditory means such as a voice synthesizer and a speaker. Depending on the choice made by the operator, the voice activation could be for only the last address or alternatively it could be continuous and it could be turned off only after pressing the button again. The continuous voice is implemented to help the operator of the vehicle to track his/her location continuously when searching for an address by looking at the display or hearing it. As depicted in FIG. 13g, display 560 is used for displaying addresses. An LCD type of-display is a preferred choice due to size and power consumption. In a typical circumstance when the operator of the vehicle forgets the location where he/she has parked the vehicle, upon pressing button 561 the display is activated and the address is displayed or alternatively, if it button is pressed twice, a voice synthesizer provides the information aurally. Depending on the preference, when button 561 is pressed the RLV unit displays the information or turning on the backlight or voice activation alone or in conjunction with displaying the information.

Depending on which functions are implemented, the key fobs depicted in FIGS. 13a, 13b, 13c, 13d, 13e, 13f, 13g, 13h and 13i can all include a built-in antenna. However, the external antenna is only used when the ignition key is inside the ignition key slot for an improved operation. Likewise, depending on what the implemented on these key fobs, the electrical contact points and insulators might be absent.

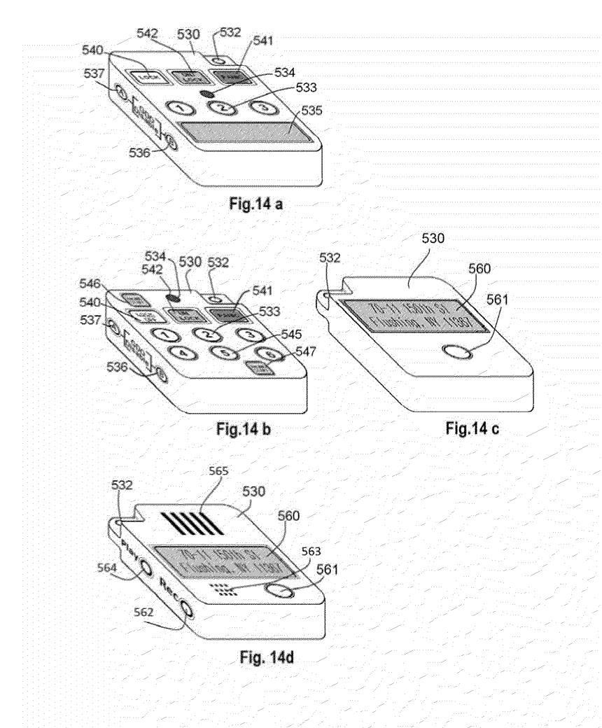

FIG. 14a depicts an independent fob (without a key blade), wherein the buttons and their pertinent functions are similar to the key fob depicted in FIG. 13e.

FIG. 14b depicts an independent fob (without a key blade), wherein the buttons their pertinent functions are similar to the key fob depicted in FIG. 13f.

In another preferred embodiment, an RLV unit is implemented on a fob without any key blades and the data is transferred to the fob wirelessly or through designated contact points from the GPS as depicted in FIGS. 14c and 14d.

FIG. 14c depicts an independent fob (without a key blade), wherein the buttons are similar to the key fob depicted in FIG. 13g. This fob can represent a standalone RLV unit or it can be one side of a combination unit wherein its other side is a UT and/or RKE as depictions of FIG. 14a or 14b. According to this embodiment of the present invention, display 560 is used for displaying the location where the vehicle is parked. The location information is supplied by the GPS receiver which is available in the vehicle either by wireless means immediately after the ignition is turned off. Display unit 560 is used for displaying the address/location where the vehicle was parked and can be realized with an LCD or other display technologies. Upon pressing key 561 the display is activated and displays the address information. However, according to another preferred embodiment, the address information is continuously displayed and the activation is turning on the backlight or voice activation alone or in conjunction with displaying the information (e.g., FIGS. 13i, 14d).

According to a preferred embodiment of the present invention, the communications between the RLV unit to the GPS system is via a wireless link. In such a case in order to save battery, only a small fraction of the time the receiver in the RLV unit is turned on by an internal clock and only when the presence of a transmit signal is sensed the receiver is turned on for a longer time sufficient as needed for receiving the data. Upon turning off of the ignition, the transmitter which is located as a part of the vehicle or as a part of the GPS system, produces a repeating transmit signal in order to assure that there would be sufficient time for the receiver to get turned on and receive the location data.

FIG. 14d depicts a fob similar to the fob depicted in FIG. 14e. This fob can represent a standalone independent RLV unit or it could be a part of a combination unit which its other side is depicted on FIG. 14a or 14b. According to this embodiment of the present invention, there is a voice recording and retrieval mechanism. As depicted, matrix holes 563 are located on the fob 530 for providing air path ways to the microphone needed for recording and a plurality of slot holes 565 are provided for providing air path ways for said miniature speaker. Button 562 is pressed by the user when recording. There is a legend “Rec” (abbreviation for Record) written next to this button. Similarly, button 564 is pressed by the user when the recorded message is being played and marked with the legend “Play”. The voice retrieval could be based on data supplied from a built in or external to the fob voice synthesizer (converting address information into voice) and/or based on recorded audio (recorded by user).

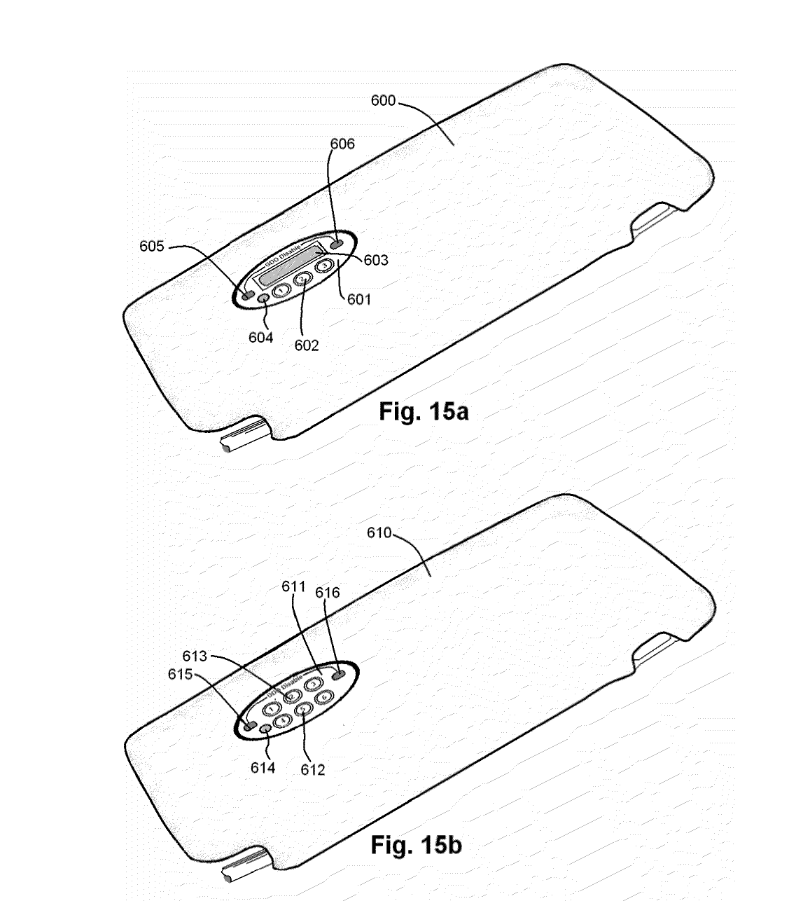

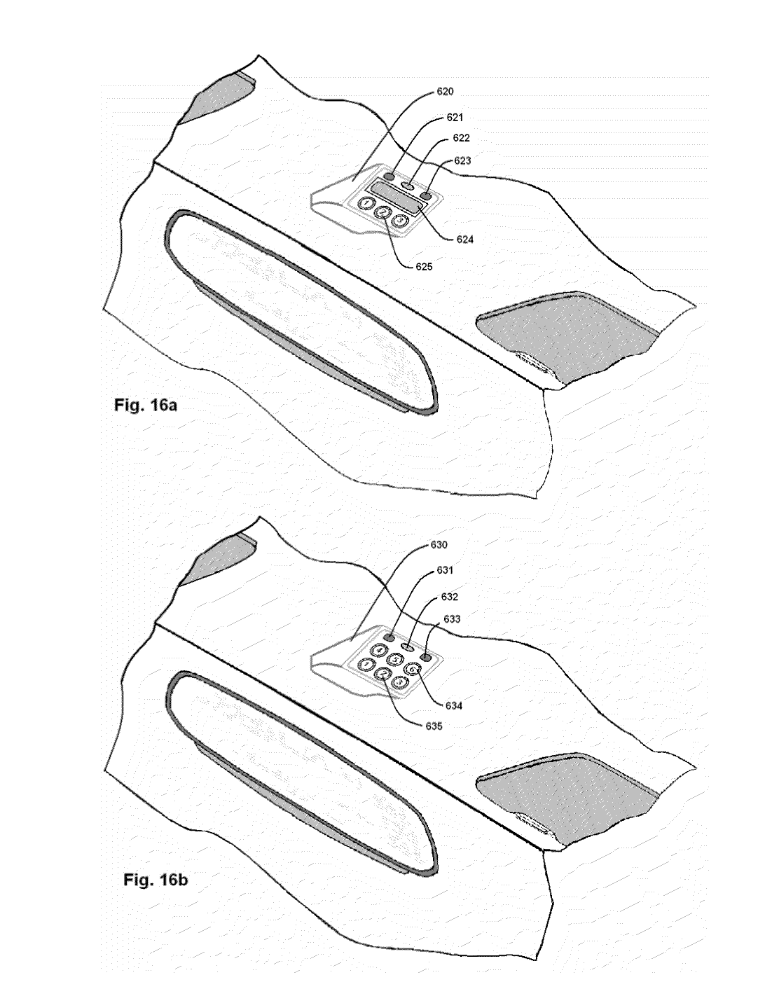

FIG. 15a depicts an implementation UT according to the present invention on a visor. According to this figure, housing 601 is put in visor 600. Button 602 is one of the three buttons for the activation of the UT. Touch pad 603 is the interface for the authentication hardware. Buttons 605 and 606 are for disabling the transmit function.

FIG. 15b depicts an implementation UT similar to FIG. 15a. According to this embodiment of the present invention, the touch pad is replaced by a secondary row of keys which in combination with the first row provide the authentication hardware. According to this implementation, the authentication procedure is performed by entering a security code.

FIG. 16a is another implementation of the present invention in which a set of buttons, LED and touchpad identical to those of FIG. 15a are realized on overhead console 620. Button 625 is one of the three buttons for the activation of the UT. Touch pad 624 is interface for the authentication hardware. Buttons 621 and 623 are for disabling the transmit function. LED 622 is utilized to indicate to the user the various status of the UT.

FIG. 16b is an implementation of the present invention wherein identical set of buttons and LED as the implementation of FIG. 15b are implemented on overhead console 630. As depicted, button 634 is one of the three buttons for the activation of the UT and button 635 is one of the three buttons in a secondary row of buttons which are used for activation of the UT as well as the authentication procedure. Buttons 631 and 632 are for disabling the transmit function. LED 632 is utilized to indicate to the user the various status of the UT.

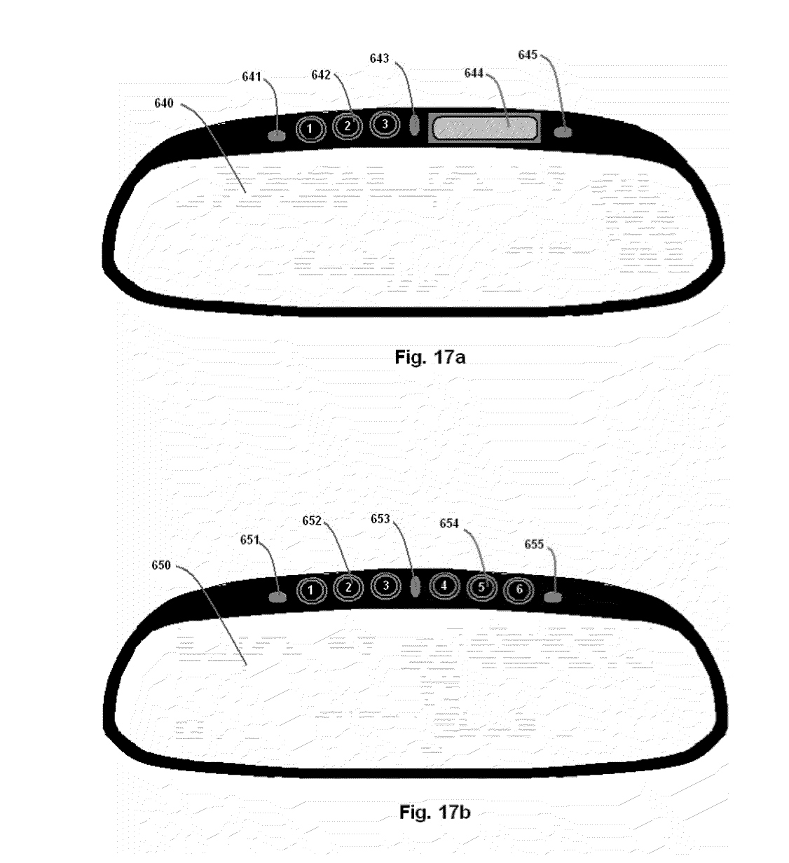

FIG. 17a is an implementation of the present invention wherein identical set of buttons, LED and touchpad as the implementation of FIG. 15a are realized on the outer frame of a rearview mirror 640. Button 642 is one of the three buttons for the activation of the UT. Touch pad 644 is interface for the authentication hardware. Buttons 641 and 645 are for disabling the transmit function. LED 643 is utilized to indicate to the user the various status of the UT.

FIG. 17b is an implementation of the present invention wherein identical set of buttons and LED as the implementation of FIG. 15b are realized on the outer frame of a rearview mirror 650. As depicted, button 652 is one of the three buttons for the activation of the UT and button 654 is one of the three buttons in a secondary row of buttons which are used for activation of the UT as well as the authentication procedure. Buttons 651 and 655 are for disabling the transmit function. LED 653 is utilized to indicate to the user the various status of the UT.

In an alternative preferred embodiment of the present invention, the touch pads are replaced with microphones to be used in conjunction with voice recognition hardware for authentication of the user.

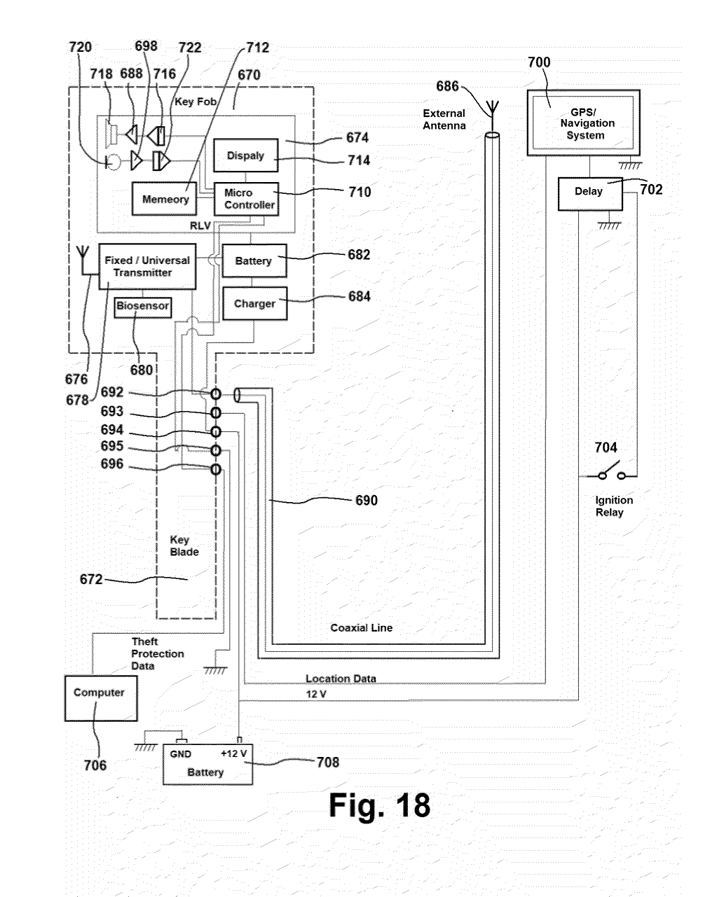

FIG. 18 is a block diagram for the internal components of an ignition key with a fob in which several embodiments of the present invention are realized, i.e., Transmitter 678 which could be a universal transmitter (UT) or a fixed transmitter, built-in antenna 676 (used only when the external antenna is not being used), RLV 670, biosensor 680 used for authentication, and a theft protection utilizing micro-controller 710 and memory device 712, charger circuit 684 and rechargeable battery 682.

According to this implementation RLV section is composed of micro-controller 710, memory device 712, display 714, audio record and play circuitry (comprised of an ADC 716 and a DAC 722 and audio amplifiers 688 and 698) to interface with microphone 720 and speaker 718. During the sound recording process, sound waves are converted into electrical signals which in turn are amplified and digitized by ADC 716 and processed by micro-controller 710 and stored in memory device 712. During the sound playing process, pertinent data is retrieved from memory device 712, converted to analog signals by means of DAC 722, and amplified and converted to sound by speaker 718.

According to the implementation depicted in FIG. 18 for the present invention, key blade 672, has 5 electrical contact points 692, 693, 694, 695 and 696.

Contact point 696 is used for data transfer needed for theft protection, i.e., identification codes are stored in memory device 712 and processed through micro-controller 710 which communicates with the computer 706 in the vehicle. The data which is used for authentication of the key fob can be fixed codes or alternatively, for high security use they can be comprised of variable codes which are also referred to as rolling codes. Computer 706 does not allow the ignition in the engine of the vehicle unless the appropriate code is recognized.

Contact point 695 provides the ground connection to the circuitry in key fob 670.

Contact point 694 is used for connection to vehicle battery 708 utilized for recharging the battery 682 by means of charger 684.

Contact point 692 provides connection between transmitter 676 and a transmission line 690 which is connected to external antenna 686. As discussed above the use of external antenna is for providing a good path to garage door opener receivers which could be implemented on windshield, dashboard top or the area behind the rear view mirror.

Contact point 693 is used to provide connection between the GPS receiver 700 available in the vehicle and the RLV 674. When the ignition switch is turned off, relay contacts 704 are opened an as a result delay circuit 702 is deactivated, i.e., after a nominal delay, e.g., 100 ms the power supply to the GPS receiver is disabled. This time delay is necessary to provide time for transfer of data about the location of the vehicle after the ignition is turned off.

### REFERENCE

[1] Edward S. Yang, Fundamentals of Semiconductor Devices (1978).
[2] Kai Chang, Handbook of Microwave and Optical Components, Volume 2 (1990).

What is claimed is:

1. A universal transmitter, said transmitter employing a time domain technique for determining the frequency of the reference transmitter during a training procedure.

2. A fob or key fob, said fob or key fob carrying location information of where an associated vehicle was last parked, said location information being provided to an operator of said vehicle by any of voice or display.

3. A wide band antenna comprising:
A plurality of resonant antennas which have either one of parallel or series resonances and are attached in either one of series or parallel.

4. A universal transmitter according to claim 1 which utilizes an adjustable gain amplifier in its receiver section in order to diminish the variations in the received signal level by producing a standard signal amplitude level for further signal processing.

5. A universal transmitter according to claim 1 which uses a Direct Digital Synthesis in order to generate a low distortion signal.

6. A universal transmitter according to claim 1 which uses a numerical oscillator in order to generate a low distortion signal.

7. A universal transmitter which uses a voltage controlled oscillator utilizing a secondary feedback mechanism in order to control the amplitude of the generated wave at sufficiently low level for a substantially distortion free output in conjunction with a staircase generator for frequency stability.

8. A universal transmitter which for security measures includes means by which its transmission function can temporarily be disabled and upon user authentication procedure is enabled.

9. A universal transmitter according to claim 8 which utilizes a biometric device or a voice recognition mechanism or a code entry by user for user authentication.

10. A fob or key fob which includes universal transmitter and can reproduce the code and the frequency for multiple reference transmitters, said reference transmitters are used for different functions both a garage door opener and produce and/or reproduce remote entry system.

11. A fob attached to a key blade; said key blade contains a plurality of electrical contacts points are internally connected circuitry inside said fob and are separated by insulators; said electrical contact points are used for electrical connection when said key blade is in an ignition key slot; said contacts used for authentication of the key, recharging the battery of said key fob, connection to external antenna and communication with a navigation system.

12. A wide band antenna according to claim 3 wherein the radiating elements are comprised of electrically conducting loops exhibiting inductive reactance/suceptance resonated with overlay or inter-digital capacitive elements.

13. A fob or key fob, said fob according to claim 2 which additionally includes a universal transmitter.

14. A universal transmitter according to claim 1 which utilizes numerical methods for determining the characteristics of frequency modulated signals emitted from a reference transmitter.

15. A universal transmitter according to claim 1 which utilizes a wide band antenna according to claim 2.

16. A universal transmitter according to claim 1 which utilizes a plurality of wide band antennas according to claim 2 to cover a plurality of frequency bands wherein said plurality of wide band antennas are located inside each other.

17. A fob or key fob, said fob or key fob receiving continuous location information of where an associated vehicle is traveling and upon user activation providing said location information to the an operator of said vehicle by any of voice or display.
